(19) United States
(12) Patent Application Publication
(10) Pub. No.: US 2026/0247108 A1
(43) Pub. Date: Aug. 20, 2026

(54) NETWORK CENTRIC METHODS FOR MANAGING SPATIAL ANCHORS IN 3GPP SYSTEMS

(71) Applicant: InterDigital Patent Holdings, Inc., Wilmington, DE (US)

(72) Inventors: Dale SEED, Allentown, PA (US); Quang LY, North Wales, PA (US); Lu LIU, Conshohocken, PA (US); Catalina MLADIN, Hatboro, PA (US)

(73) Assignee: InterDigital Patent Holdings, Inc., Wilmington, DE (US)

(21) Appl. No.: 19/472,160

(22) PCT Filed: Mar. 29, 2024
(86) PCT No.: PCT/US2024/022132

§ 371 Date: Oct. 3, 2025

Related U.S. Application Data
(60) Provisional application No. 63/457,485, filed on Apr. 6, 2023.

(51) Int. Cl. H04W 4/029; H04W 4/02

(52) U.S. Cl. CPC H04W 4/029; H04W 4/023; H04W 4/026

(57) ABSTRACT

Described herein are methods and procedures to enhance the 3GPP system with XRM Server functionality to assist VAL servers with the creation and management of spatial anchors. For example, an XRM server may send a spatial anchor ranging request to one or more other services. The one or more other services may determine ranging distances and orientations between a spatial anchor and a user device and send the ranging distances and orientations to the XRM server. The XRM server may receive the ranging distances and orientations, compare the received ranging distances and orientations with predetermined ranging distance and orientation limits for the spatial anchor, and based on the ranging distances and orientations limits being greater than the received ranging distances and orientations, perform one or more spatial anchor operations.

### CROSS-REFERENCE TO RELATED APPLICATIONS

This application claims benefit of U.S. Provisional Application No. 63/457,485 (titled “Network Centric Methods for Managing Spatial Anchors in 3GPP Systems”) filed Apr. 6, 2023, the contents of which are hereby incorporated by reference in its entirety for any and all purposes.

### BACKGROUND

The 3GPP system currently lacks network centric capabilities to assist VAL servers with the creation and management of spatial anchors. For example, VAL servers lack the capability to create spatial anchors within the 3GPP system and anchor these spatial anchors to objects (e.g., a UE). Additionally, VAL servers lack the capability to offload the management of spatial anchors to a function in the 3GPP system, such that some spatial anchor operations can be offloaded and performed on the VAL server's behalf, such as a capability to assist a VAL server in detecting if/when the location of an entity (e.g., UE) comes within range of a spatial anchor, and a capability to assist a VAL server in detecting if/when an entity (e.g., UE) is within in a certain orientation or distance of a spatial anchor (e.g., a UE is moving towards or away from a spatial anchor). For use cases which require mobile spatial anchors (e.g., food trucks, concert tours, traveling sports teams), VAL server lack a capability to anchor a spatial anchor to a UE such that the location, orientation and/or distance of the spatial anchor tracks the location, orientation and/or distance of the UE.

### SUMMARY

Described herein are methods and procedures to enhance the 3GPP system with XRM Server functionality to assist VAL servers with the creation and management of spatial anchors. This proposed functionality provides network centric spatial anchor management functionality in a 3GPP system.

For example, an XRM server supporting spatial anchor server functionality that receives requests from VAL servers may perform the following types of spatial anchor operations and receive responses in return: create and store information for one or more spatial anchors (either locally at the XRM server or remotely at another server in the 3GPP system such as a SEALDD server), wherein the spatial anchor information elements may be comprised of one or more elements defined in the table below; update spatial anchors to modify one or more spatial anchor information elements such as the elements defined in the tables herein; discover spatial anchors meeting one or more specified criteria such as those defined in the tables herein; retrieve spatial anchors to obtain information elements such as those defined in the tables herein for a one or more spatial anchors; subscribe/unsubscribe to spatial anchors to receive spatial anchor notifications based on the detection of spatial anchor related events that are of interest to a VAL server such as a UE entering within a specified range of the spatial anchor, etc.: delete spatial anchors such that spatial anchor information is removed the XRM server and/or other servers such as a SEALDD server; retrieve XRM information from the XRM server which the VAL server can then use to create or update a spatial anchor; and wherein the XRM server may support a RESTful API to receive the aforementioned spatial anchor requests from a VAL server, process these requests and store spatial anchor information within spatial anchor resources (hosted locally by the XRM server and/or remotely on other functions and services in the 3GPP system), and return the aforementioned responses back to a VAL server in a RESTful manner.

A further example may be an XRM server supporting spatial anchor server functionality to perform the following types of spatial anchor operations: determine whether consent has been given to track a UE's location, orientation and distance for purposes of spatial anchor management; send and receive requests and responses to/from other functions or services in the 3GPP system to collect location, orientation and/or distance information for UEs in proximity to spatial anchors; send and receive requests and responses to/from other functions or services in the 3GPP system to anchor a spatial anchor to an object (e.g., a UE or a non-3GPP device); store spatial anchor context information locally on the XRM server or remotely at other functions and services in the 3GPP system: track the location, orientation and distance of a spatial anchor anchored to either a fixed object (e.g., a store shelf) or a non-fixed object (e.g., UE): determine the current or expected location of one or more UEs compared to the location of a spatial anchor; determine the positioning (e.g., direction or speed) of one or more UEs compared to the location, orientation and distance of a spatial anchor; determine if/when the location, orientation and distance of UE is within a specified range and alignment with that of a spatial anchor; determine whether a spatial anchor is of interest to a UE based on spatial anchor context information; determine whether UEs are authorized to access spatial anchor context information; create spatial anchor notifications comprising spatial anchor context information; send spatial anchor notifications to VAL servers and/or UEs; and wherein the XRM server may initiate performing the aforementioned spatial anchor operations upon receiving requests from VAL servers, receiving requests from other functions or services in the 3GPP system, or based on triggers that the XRM server generates (e.g., based on local XRM server policies).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings: however, the subject matter is not limited to specific elements and instrumentalities disclosed. In the drawings:

FIG. 1 shows an example of real-world AR spatial anchors;

FIG. 2 shows an example of virtual-world VR spatial anchors:

FIG. 3 shows an example of a network centric spatial anchor services architecture;

FIG. 4 shows an example of an overview of network centric spatial anchor procedures;

FIG. 5 shows an example of a VAL server initiated XRM context discovery and retrieval;

FIG. 6 shows an example of a VAL server initiated spatial anchor create and update request;

FIG. 7 shows an example of a VAL server initiated spatial anchor retrieval and discovery;

FIG. 8 shows an example of a VAL server initiated spatial anchor subscription;

FIG. 9 shows an example of a VAL server initiated spatial anchor unsubscribe;

FIG. 10 shows an example of a VAL server initiated spatial anchor delete;

FIG. 11 shows an example of XRM server initiated spatial anchor context operations to other services:

FIG. 12 shows an example of XRM server initiated spatial anchor anchoring operations;

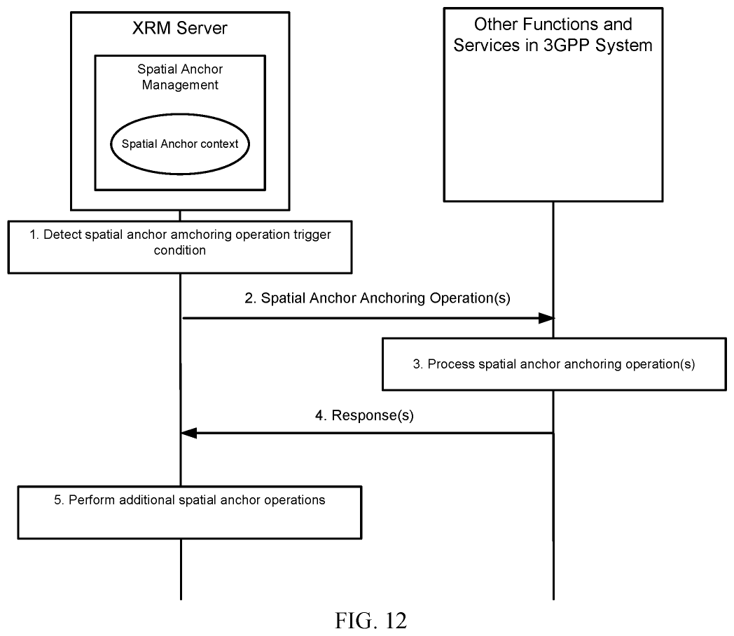

FIG. 13 shows an example of XRM server initiated spatial anchor location and distance operations:

FIG. 14 shows an example of XRM server initiated spatial anchor ranging operations;

FIG. 15 shows an example of a XRM server initiated spatial anchor notification;

FIG. 16 shows an example of a XRM server spatial anchor GUI;

FIG. 17A illustrates an example communications system in which the methods and apparatuses described and claimed herein may be embodied;

FIG. 17B is a block diagram of an example apparatus or device configured for wireless communications;

FIG. 17C is a system diagram of an example radio access network (RAN) and core network:

FIG. 17D is a system diagram of another example RAN and core network:

FIG. 17E is a system diagram of another example RAN and core network:

FIG. 17F is a block diagram of an example computing system; and

FIG. 17G is a block diagram of another example communications system.

### DETAILED DESCRIPTION

Described herein are methods and procedures to enhance the 3GPP system with XRM Server functionality to assist VAL servers with the creation and management of spatial anchors.

The following abbreviations may be used herein:

| | |
|---|---|
| 3GPP | Third Generation Partnership Project |
| 5GS | 5G System |
| 6GS | 6G System |
| AF | Application Function |
| API | Application Programming Interface |
| AR | Augmented Reality |
| AS | Application Server |
| EAS | Edge Application Server |
| EEC | Edge Enabler Client |
| EES | Edge Enabler Server |
| FQDN | Fully Qualified Domain Name |
| GUI | Graphical User Interface |
| MNO | Mobile Network Operator |
| NEF | Network Exposure Function |
| RAN | Radio Access Network |
| TACMM | Tactile and multi-modality communication services |
| UE | User Equipment |
| URI | Uniform Resource Identifier |
| VAL | Vertical Application Layer |
| VR | Virtual Reality |
| XR | eXtended Reality |
| XRM | eXtended Reality and Media services |

Augmented Reality (AR) and Virtual Reality (VR) technologies have been tantalizing users for some time for providing an immersive user experience, especially in the gaming industry. In AR, computer graphics are overlayed into a real-world view where a user can then interact with the added graphics to obtain more information about an object present in the user's view. VR, on the other hand, presents a user with a computer-generated virtual environment in which the user can interact with objects in the virtual world.

In both AR and VR, users may for example participate in a gaming session and feel as if they are part of the action. The action may be to guide a hero to infiltrate enemy territory, to navigate in a high-speed car chase, or to duel an opponent in a sporting event. The user may interface to the AR/VR application through wearable devices such as glasses/goggles, headsets, tactile gloves, and other bodily sensors. Users may transmit audio and visual information to the AR/VR application and to another user who may be involved in the gaming session.

An AR/VR service provider may host an application server in the cloud for which many users may gain access to the AR/VR application regardless of their locations. Users may utilize smartphones and/or AR/VR glasses within a static location or the user may be mobile. The mobile devices may require connectivity provided by a Mobile Network Operator's (MNO) cellular communication system.

eXtended Reality (XR) is a term used to describe technologies that enhance a user's view of the real and/or virtual world and therefore may encompass AR, VR, or a combination of both. When multiple users benefit from the same AR/VR/XR immersive experience, a term commonly used to describe such a scenario is the users are interacting with the metaverse. In other words, metaverse refers to the interactions of multiple XR users simultaneously while providing an immersive experience to each user as if they were all interacting in the same location.

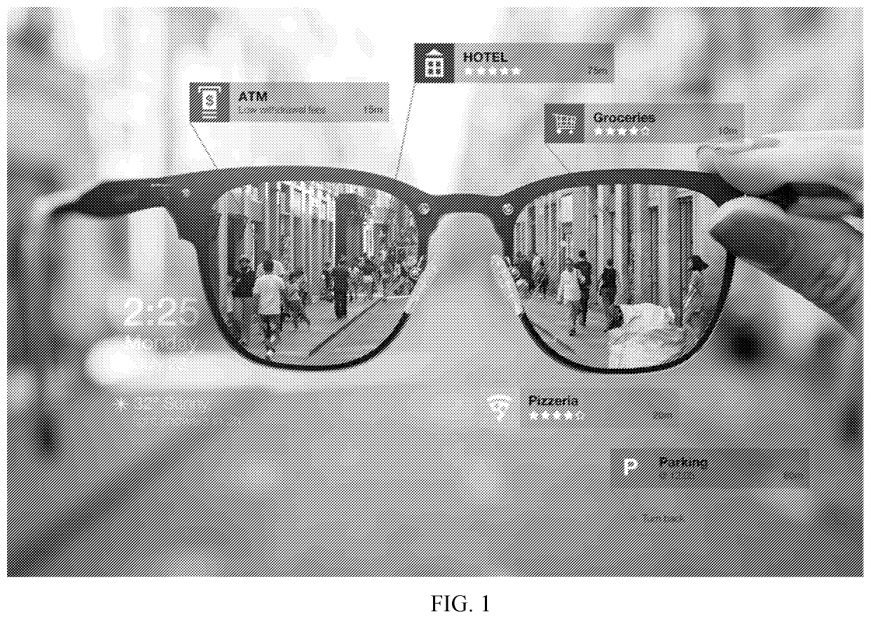

Spatial anchors connect locations in a virtual and/or real-world environment with digital content. For example, FIG. 1 shows spatial anchors in a real-world AR use case involving a shopping mall. In this environment, spatial anchors may be anchored to store fronts in a shopping mall. Each spatial anchor may have a configured location tied to the location of a storefront. Each spatial anchor may also have digital content associated with it (e.g., product advertisements). These spatial anchors may be used to attract potential customers into the stores and guide them to products which meet their personalized shopping preferences (e.g., personalized advertisements and discounts on products they typically buy). These spatial anchors may be viewed on a customer's personal device (e.g., a smart phone or smart glasses) as they walk about the shopping mall.

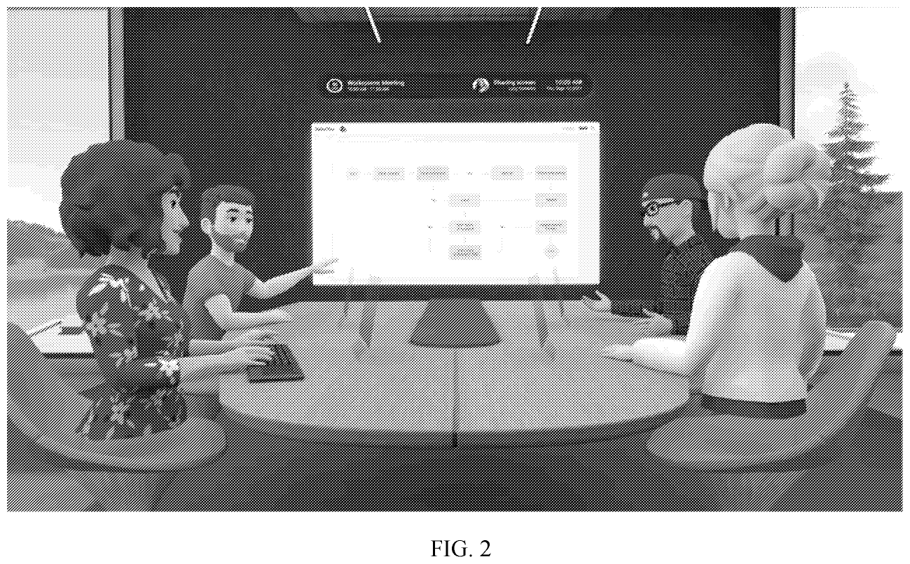

In contrast, FIG. 2 shows spatial anchors used in a virtual-world VR use case such as a VR experience. In this type of use case, the spatial anchors may be anchored to virtual objects which are rendered and placed throughout a virtual environment. For example, virtual walls, windows, and furniture located within a virtual room. The locations of the spatial anchors in these types of virtual-world use cases may be based on a virtual mapped layout of the virtual room/setting. These spatial anchors may be used to place and render the virtual objects in the virtual environment with respect to the location and distance of the user being immersed in the virtual environment. For example, as a user wearing a headset device moves around a room and changes their location and viewing angle, the spatial anchors of each virtual object in the room may be used to change how the objects are rendered and viewed by the user (e.g., the pose and viewing angle of each object is modified based on the user's location and viewing angle).

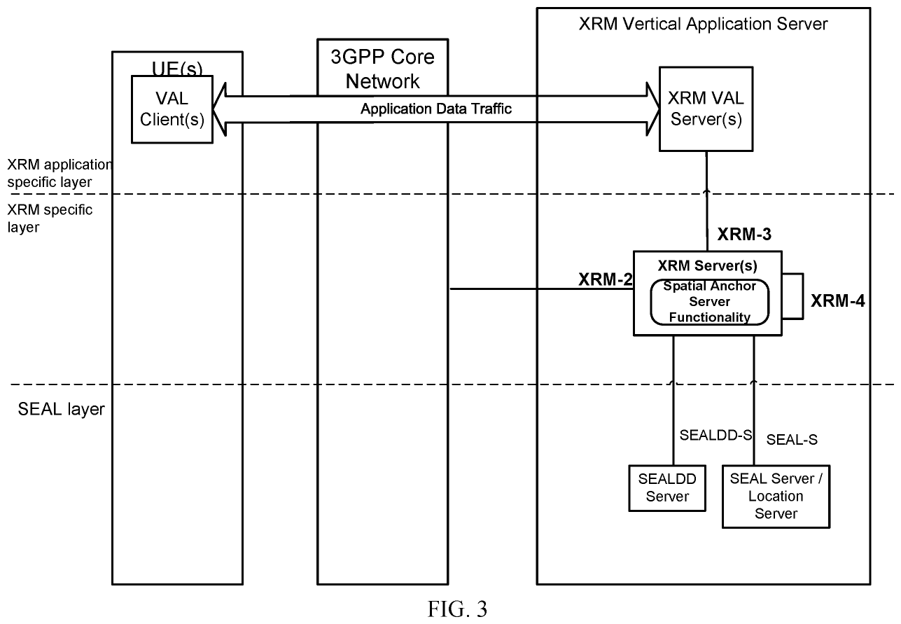

FIG. 3 illustrates a proposed architecture for supporting network centric spatial anchor services within the context of a 3GPP system. The architecture defines an XR and Media (XRM) server in a 3GPP system which supports spatial anchor server functionality. The XRM server and its supported spatial anchor services may be accessed and used by VAL servers to create and offload the management of VAL server defined spatial anchors to the XRM server to manage on behalf of VAL servers. To manage these spatial anchors, the XRM server may also interface to other functions and services in the 3GPP system such as but not limited to those shown in this proposed architecture. For example, the XRM server may interface to the functions within the 3GPP Core Network, 3GPP defined SEALDD servers and services, and 3GPP defined SEAL servers and services such as but not limited to location management, group management, and network resource management supported by SEAL.

One skilled in the art will recognize that this proposed architecture is not intended to limit or exclude other possible architectural options for supporting spatial anchor services within the 3GPP system. For example, rather than spatial anchor server functionality being supported and defined within an XRM server, the spatial anchor server functionality may be realized as a separate standalone server such as an Application Function (AF) in the 3GPP system. Alternatively, the spatial anchor server may be realized as functionality supported by other services within the 3GPP system such as but not limited to a SEALDD or SEAL server.

To interface the XRM server with other functions and services in the 3GPP system as well as to one or more VAL servers, new reference points such as the ones shown in FIG. 3 may be defined. For example, an XRM-2 reference point may be defined and used by the XRM server to interface to the 3GPP network (e.g., to query location information for UEs either anchored to or in proximity of spatial anchors). XRM-2 may rely on existing 3GPP defined northbound interfaces such as the NEF N33 reference point. An XRM-3 reference point may be defined and used by a VAL server to interface to an XRM server (e.g., to create, update, discover, retrieve, subscribe, unsubscribe, and delete spatial anchors which an XRM server manages on behalf of a VAL server). An XRM-4 reference point may be defined and used by XRM servers to interface to another XRM server (e.g., to discover and exchange spatial anchor information with other XRM servers).

In addition, an XRM server may also interface to other functions and services defined in the 3GPP system via their corresponding reference points. For example, the SEALDD-S reference point used by an XRM server to interface to a SEALDD server (e.g., to store and access spatial anchor context information within a SEALDD server and/or a SEALDD storage server). The SEAL-S reference point may be used by an XRM server to interface to a SEAL server and one or more of its supported SEAL services such as SEAL location management server (e.g., to store and/or access spatial anchor location information).

The XRM server shown in FIG. 3 may also be deployed by a cloud service provider offering XRM spatial anchor services which may or may not communicate with the 3GPP network. The cloud service provider may expose API's for VAL servers to access the spatial anchor services described in this invention.

The following table defines network centric spatial anchor context information that may be transmitted, received, stored, updated, processed, and/or generated by various entities in a 3GPP system such as but not limited to an XRM server, SEAL server, SEALDD server, or one or more corresponding clients that communicate with these servers. One skilled in the art will recognize that spatial anchor context information may be comprised of additional information elements not captured in the table below.

| Informational Element | Parameter Description |
|---|---|
| VAL server ID(s) | Unique identifier(s) that identify VAL server(s) associated |
| | with the spatial anchor (e.g., Identifier of VAL server(s) that |
| | created or have authority over the spatial anchor) |
| VAL service ID | Unique identifier that identifies the type of VAL service |
| | associated with the spatial anchor (e.g., Identifier of a |
| | shopping item locator service) |
| VAL server callback | Address (e.g., IP address/port, or URL) of a VAL server |
| address(s) | which an XRM server may target when returning responses |
| | (e.g., async responses) and/or when initiating requests or |
| | notifications to a VAL server associated with the spatial |
| | anchor. |
| Spatial anchor type | An indication of a particular type of spatial anchor (e.g. |
| | advertisement, navigation, etc.). The type may also specify |
| | whether the spatial anchor is associated with a real world |
| | object such as one used in an AR application or a virtual |
| | object used in a VR application. |
| Spatial anchor ID | Unique identifier that identifies the spatial anchor and that |
| | may be used by an XRM server or VAL server to access |
| | and/or manage the spatial anchor. |
| Spatial anchor location | Spatial anchor location or distance requirements such as the |
| or distance | required location or distance precision (e.g., 1 m, 10 cm, etc.), |
| requirements | required location or distance dimensionality (e.g., 2D, 3D), |
| | location or distance format (e.g., geospatial, etc.) when |
| | computing whether UEs are within the service area of the |
| | spatial anchor. |
| Spatial anchor location | Current location or distance of the spatial anchor or of an |
| or distance | object with respect to a spatial anchor. For example, an |
| | outdoor mapped location (e.g., GPS location coordinates) or |
| | an indoor mapped location such as the coordinates of a |
| | product on a store shelf which the spatial anchor is anchored |
| | to. |
| Spatial anchor | Spatial anchor orientation requirements such as directionality |
| orientation | requirements, angle of arrival requirement or heading |
| requirements | requirements. |
| Spatial anchor | Current orientation of the spatial anchor or the orientation of |
| orientation | an object with respect to the spatial anchor. Orientation may |
| | be expressed as a current position, direction, or angle or |
| | arrival (e.g., the rotational position / direction a spatial |
| | anchor is facing, pointing, or moving). For example, a spatial |
| | anchor may be anchored to a digital sign facing in a certain |
| | direction. |
| Anchored object ID of | Identifier of an object to which the spatial anchor is anchored |
| spatial anchor | to. This identifier may be used to associate a spatial anchor to |
| | one or more objects in the real-world or a virtual-world. For |
| | example, a spatial anchor may be anchored to a store shelf. |
| | The store shelf may shelve multiple items. The spatial anchor |
| | may be anchored to the shelf, or it may be anchored to one or |
| | more individual items on a store shelf. |
| Spatial anchor tracking | An indication of whether the XRM server is to track and |
| enabled | update the location, orientation and/or distance of a spatial |
| | anchor if/when the location, orientation or distance changes |
| | (e.g., if a spatial anchor is moved to a different location, its |
| | distance or orientation has changed, or the object(s) which the |
| | spatial anchor is anchored to changes location, orientation or |
| | distance). |
| Location server | Information such as an ID or address of one or more location |
| information | services in the 3GPP system (e.g. SCEF/NEF location API, |
| | SEAL location servers) that the XRM uses to collect location, |
| | orientation and/or distance information for the spatial anchor, |
| | an object anchored to the spatial anchor, or UE(s) that are |
| | within proximity to the spatial anchor. |
| Spatial anchor service | Service operating area of the spatial anchor. May include |
| area range | location range limits (e.g., within 500 ft of spatial anchor) |
| | and/or distance or orientation range alignment (e.g., heading |
| | toward the spatial anchor) which may be used by the XRM |
| | server to detect if/when objects meet the service area limits |
| | and requirements of the spatial anchor. |
| Spatial anchor ranging | An indication of whether the XRM server is to track and |
| enabled | detect if/when a UE comes within the defined range limits of |
| | the spatial anchor. |
| Spatial anchor content | An indication of the type of digital content (e.g., VAL content |
| type | ID) that is either linked to the spatial anchor or that is |
| | embedded and stored within the spatial anchor. |
| Spatial anchor content | A link (e.g., URI) to content or services associated with the |
| link | spatial anchor. For example, a link to content stored on a |
| | VAL server or SEALDD server or a link to a service API of a |
| | VAL server or 3GPP defined server. This link may be used to |
| | access content or services associated with the spatial anchor. |
| VAL server availability | If a spatial anchor is linked to content or services provided by |
| | a VAL server, this information element may be used to |
| | provide the scheduled availability of the VAL server and |
| | when the content may be accessed. This information element |
| | may be used by an XRM server or another entity (e.g. VAL |
| | client) when accessing content or services linked to a spatial |
| | anchor. |
| Spatial anchor content | Spatial anchor content that is embedded and stored within the |
| | spatial anchor (rather than content that is link to a VAL |
| | server). For example, VAL content may be stored within the |
| | spatial anchor by a VAL server such that the content may be |
| | accessed by other entities without having to communicate |
| | directly with the VAL server. |
| Spatial anchor status | A status indicating whether the spatial anchor is currently |
| | active or inactive. For example, this indicator may be a |
| | Boolean or enumerated type value indicating whether the |
| | spatial anchor is active (i.e. True) or inactive (i.e., False). |
| | When inactive, discovery and interaction with the spatial |
| | anchor by other entities in the 3GPP system may be blocked |
| | by the XRM server. |
| Spatial anchor schedule | A time window indicating time periods for when the spatial |
| | anchor is scheduled to be active or inactive. When inactive, |
| | the XRM server may not perform spatial anchor management |
| | operations and/or may prevent other entities in the 3GPP |
| | system from performing operations involving the spatial |
| | anchor. |
| Spatial anchor | Spatial anchor subscription information may include one or |
| subscription | more of the following elements: |
| information | Subscriber information such as the identity of a VAL |
| | server that created the spatial anchor subscription. |
| | Spatial anchor subscription ID |
| | Spatial anchor subscription event criteria specifying |
| | spatial anchor events of interest to the subscriber |
| | A ranging threshold value specifying a |
| | minimum distance or orientation between this |
| | spatial anchor and UEs that may enter into its |
| | proximity |
| | A spatial anchor content type matching the |
| | content type interests of the subscriber |
| | Notification target(s) specifying contact information |
| | (e.g., IP address, port, URI) where spatial anchor |
| | notifications are sent by the XRM server if/when |
| | spatial anchor event criteria for this subscription have |
| | been met. |
| | Notification content specifying what spatial anchor |
| | information elements should be included (or excluded) |
| | in a notification that is sent to a notification target |
| | (e.g., spatial anchor ID, spatial anchor content, etc.) |
| Spatial anchor | Spatial anchor discovery information that can be used as |
| discovery information | criteria within spatial anchor discovery filters. For example, |
| | descriptive labels and metadata describing a spatial anchor |
| | and/or an object which is anchored to the spatial anchor. |
| Spatial anchor access | One or more access tokens accepted by the XRM server to |
| token(s) | gain access to the spatial anchor. When receiving a request to |
| | access the spatial anchor which includes an access token, the |
| | XRM server may compare the received token to these tokens |
| | stored in the spatial anchor. If a match is found, access may |
| | be allowed, otherwise access may be forbidden. |
| Spatial anchor access | One or more access control policies defining access control |
| control policy(s) | rules for the spatial anchor. An XRM server may use these |
| | access control policies to determine whether or not to allow |
| | access to a spatial anchor. Spatial anchor access control |
| | policy(s) may include rules defining which entities are |
| | permitted to perform one or more operations on a spatial |
| | anchor such as create, update, discover, retrieve, subscribe, |
| | unsubscribe, or delete a spatial anchor. The rules may also |
| | define finer grain permissions such as which information |
| | elements of a spatial anchor may be accessed by different |
| | entities. The rules may also include additional context such as |
| | only entities located within a certain designated location or |
| | region, entites having a certain orientation with respect to a |
| | spatial anchor, or entities within a certain range or distance |
| | from a spatial anchor are permitted. The rules may also |
| | specify that a spatial anchor can only be accessed by a certain |
| | type of entity (e.g. a certain type of VAL client). |
| Spatial anchor | Spatial anchor advertisement policy(s) may include rules such |
| advertisement policy(s) | as advertisement range / geo-fence, advertisement schedule, |
| | UE ID(s) / group ID(s), VAL client ID(s), etc. These rules |
| | may be used by an XRM server to determine if, when, and/or |
| | which entities in the 3GPP system to advertise spatial anchor |
| | context information to. An XRM server may use |
| | advertisement policies to determine whether or not to |
| | advertise a spatial anchor to other entities (e.g., VAL clients |
| | or VAL server). |
| Anchored Status | Anchored Status - An indicator to reflect whether a spatial |
| | anchor is currently anchored to another entity (e.g. a UE) or |
| | unanchored. |

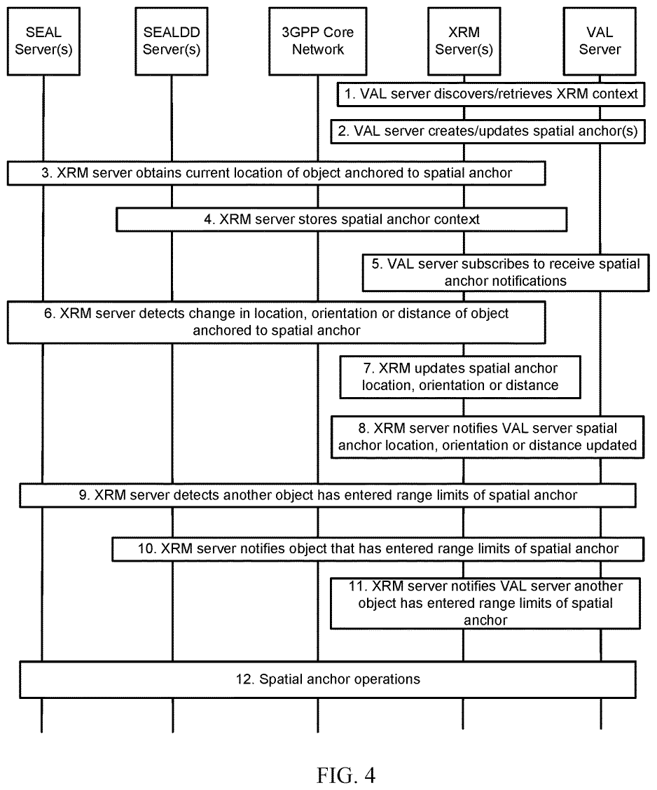

FIG. 4 provides an overview of the different types of network centric spatial anchor procedures proposed in this invention. For each of the steps defined in FIG. 4, one or more separate procedures are defined in subsequent sections of this invention which provide additional proposed functionality and detail.

Step 1: A VAL server sends one or more requests to an XRM server to discover and/or retrieve XRM context information which the VAL server may use to subsequently create one or more spatial anchors.

Step 2: The VAL server sends one or more requests to an XRM server to create one or more spatial anchors which the XRM is to manage on the VAL server's behalf.

Step 3: The XRM server interfaces to one or more functions or services in the 3GPP system to manage spatial anchors. For example, the XRM server may obtain the current location, orientation or distance of a spatial anchor, or the location, orientation or distance of an object anchored to a spatial anchor.

Step 4: The XRM server stores spatial anchor context information either locally at the XRM server or at another function or service in the 3GPP system such as a SEALDD storage server.

Step 5: The VAL server subscribes to a spatial anchor managed by the XRM server in order to receive spatial anchor notifications regarding spatial anchor events of interest to the VAL server (e.g., location, orientation or distance associated with a spatial anchor or an object in proximity to a spatial anchor).

Step 6: The XRM server interacts with other functions and services in the 3GPP system (e.g., 3GPP Core Network, SEAL location management server) and detects a change in the location, orientation and/or distance of a spatial anchor (and/or an object anchored to a spatial anchor).

Step 7: The XRM server updates the location, orientation and/or distance of the spatial anchor (or object anchored to a spatial anchor) within the spatial anchor context information stored locally at the XRM server (or remotely on another function or service in the 3GPP system such as a SEALDD storage server).

Step 8: The XRM server sends a notification to the VAL server to notify the VAL server that the location, orientation and/or distance of a spatial anchor (and/or an object anchored to a spatial anchor) has changed.

Step 9: The XRM server interacts with other functions and services in the 3GPP system (e.g., 3GPP Core Network, SEAL location management server) and detects a UE has entered the range limits of a spatial anchor.

Step 10: The XRM server sends a notification to the UE that has entered the range limits of the spatial anchor. The notification may comprise spatial anchor information which the XRM server shares with the UE.

Step 11: The XRM server sends a notification to the VAL server to notify it that a UE has entered within the range limits of the spatial anchor.

Step 12: The XRM server in conjunction with one or more other entities in the 3GPP system (e.g., VAL server, UEs, etc.) may perform additional spatial anchor aware operations. For example, the XRM server may receive requests to access VAL content or services linked to a spatial anchor or VAL content stored within a spatial anchor. The XRM server may process the requests and may interface to one or more VAL servers and/or other functions or services in the 3GPP system to do so. For example, the XRM server may forward a spatial anchor content request to a VAL server to process.

Before issuing a request to an XRM server to create, update, subscribe, unsubscribe, or delete a spatial anchor, a VAL server may first retrieve or discover XRM context stored and/or maintained by the XRM server. This XRM context may be used by the VAL server to determine whether to issue one or more subsequent spatial anchor requests to the XRM server. The XRM context may also be used by the VAL server to populate information it provides to the XRM server within the subsequent spatial anchor requests. One type of XRM context that a VAL server may discover or retrieve from an XRM server may include spatial anchor context information elements (e.g., for existing spatial anchors managed by an XRM server) such as one or more of the information elements defined in the table above. Other types of XRM context a VAL server may discover and retrieve from an XRM server may include information elements such as those defined in table below.

For example, an XRM server may store information of XRM objects in a VR scene. These XRM objects may then be discovered by a VAL server. Based on these discovered XRM objects, a VAL server may then create spatial anchors for these discovered XRM objects.

| Information | |
|---|---|
| Element | Description |
| XRM object | Information regarding one or more XRM objects for which |
| information | the XRM server has awareness of, wherein the information |
| | for an XRM object may include one or more of the |
| | following: |
| | ID of Object |
| | Object's type |
| | Object's location |
| | Object's orientation |
| | Object's distance |
| | Object's VAL service ID(s) |
| | Object's VAL Server ID(s) |
| | Object's VAL client ID(s) |

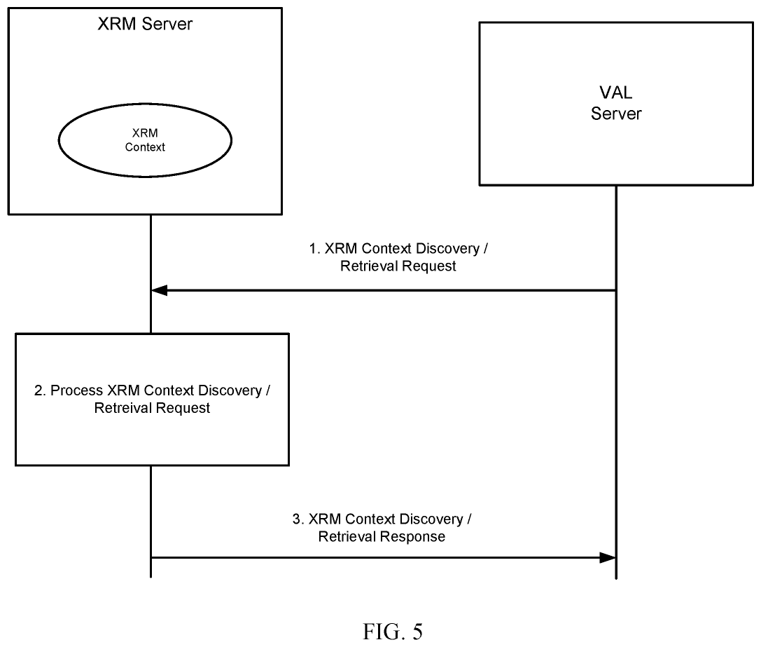

As shown in FIG. 5, a VAL server may initiate a request to an XRM server to retrieve or discover XRM context information such as but not limited to the information proposed in either or both of the tables above.

Step 1: A VAL server may issue a request to an XRM server to discover or retrieve XRM context. The request may include but is not limited to one or more XRM information elements defined in the table below.

| Information | |
|---|---|
| Element | Description |
| XRM filter | One or more criteria that may consist of variables, operators |
| criteria | and/or values. Where the variables may refer to XRM |
| | context information elements. The operators may include |
| | but are not limited to operators such as =, !=, <, >, <=, >=. |
| | The values may include numbers, strings, or complex types. |
| | Some examples of criteria may include but are not limited |
| | to XRM context such as: |
| | Location, orientation and/or distance information for |
| | one or more specified objects wherein an object may |
| | be a stationary object with a fixed location, |
| | orientation and distance or a non-stationary object |
| | whose location, orientation and/or distance may |
| | change, |
| target | Address of the XRM server or another entity in the system |
| address | that is capable of receiving and processing XRM context |
| | retrieval or discovery requests. The address may include but |
| | is not limited to the following: |
| | IP address of the target XRM server |
| | Port of the target capable of receiving XRM context |
| | retrieval/discovery requests on |
| | Identifier of a resource or topic of the XRM server |
| VAL | Identifier of the VAL server initiating the request |
| server ID | |

Step 2: Upon receiving the request to retrieve or discover XRM context, the targeted XRMV server may process the request by first checking whether the VAL server originating the request has permissions. This check may be performed by the XRM server checking that the VAL server ID specified in the request matches an ID specified in the access control privileges of the XRM server. The check may also include verifying the type of XRM server operation being performed (i.e., context retrieval or discovery) is allowed and/or allowed at the current time and/or from the current location that the VAL server resides. If allowed, the XRM server processes the request. When processing the request, the XRM server may check whether the request includes filter criteria. If present, the XRM server may compare the specified filter criteria against context information within one or more spatial anchors stored locally by the XRM server. The XRM server may also send one or more requests to other entities in the network to retrieve or discover XRM context stored elsewhere in the network (e.g., stored within SEALDD server or another XRM server). When comparing the filter criteria, the XRM server may determine whether any XRM context information matches the specified filter criteria.

Step 3: If one or more XRM contexts are found to match the filter criteria, then representations of the XRM context(s) are returned in a response to the VAL server that originated the request. Alternatively, XRM server IDs (e.g., URls) may be returned. Otherwise, an error indication is returned in the response indicating no XRM context information matching the specified filter criteria were found. The response may include but is not limited to one or more of the information elements defined in the table below.

| Information | |
|---|---|
| Element | Description |
| XRM context | See the tables above for a list of proposed spatial anchor |
| information | context Information elements that may be included for |
| | XRM context returned in the response. |
| Status | Indication of whether the request was successfully |
| | processed or not. |

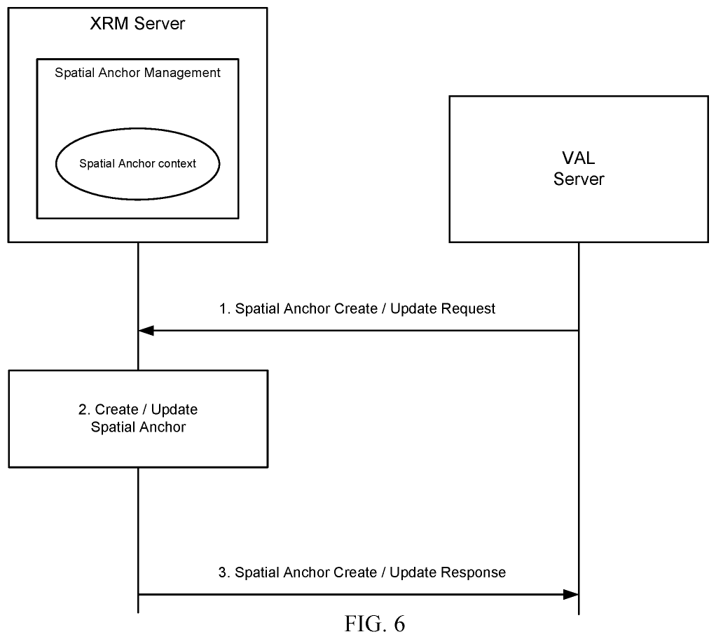

As shown in FIG. 6, a VAL server may create or update a spatial anchor by initiating a request to an XRM server. The creation or update of a spatial anchor may involve the exchange of spatial anchor context information as defined in the tables above between the VAL server and the XRM server.

Step 1: To create or update a spatial anchor, a VAL server may issue a spatial anchor create or update request to an XRM server, where the request may include but is not limited to one or more of the information elements defined in the table below. In the case of an update request, the VAL server may include a spatial anchor identifier.

| Request | |
|---|---|
| Element | Description |
| spatial anchor | See the tables above for a list of spatial anchor context |
| context | Information elements that may be included in this |
| information | request. |
| XRM server | Address of the XRM server targeted by the request may |
| address | include but is not limited to the following: |
| | IP address of a targeted XRM server |
| | Port that a targeted XRM server receives spatial |
| | anchor create/update requests on |
| | Identifier of a resource or topic (e.g., URI, topic |
| | name, etc.) hosted on a targeted XRM server which |
| | the spatial anchor context is to be created (e.g., as a |
| | child resource or sub-topic of the parent) or updated |
| | (e.g. an existing spatial anchor) |
| VAL server ID | Identifier of the VAL server initiating this request |

Step 2: Upon receiving the spatial anchor create or update request, the XRM server may process the request by first checking whether the VAL server originating the request has permissions to create or update the spatial anchor on the XRM server. This check may be performed by the XRM server checking that the VAL server ID specified in the request matches an ID specified in the access control privileges of the XRM server. The check may also be performed by checking whether a token specified in the request matches a token specified in the targets spatial anchor(s). The check may also include verifying the type of XRM spatial anchor operation being performed is allowed as well as if the operation is allowed to be performed at the current time and/or from the current location that the VAL server resides. If allowed, the XRM server creates or updates the spatial anchor context. When creating or updating the spatial anchor context, the XRM server may also perform one or more of the following operations based on spatial anchor context information contained within the request:

Assign a spatial anchor ID and/or address to the spatial anchor if one is not already assigned and/or included in the request.

Identify one or more spatial anchors associated with the received request. If a spatial anchor is being created and a spatial anchor ID is not specified in the request, then a new spatial anchor ID may be generated and assigned to the spatial anchor by the XRM server. If the spatial anchor(s) are being updated by the request, the spatial anchor context information in the request may be used to update one or more information elements of the existing spatial anchor(s) stored and managed locally by the XRM server or stored and managed by other functions in the network such as other XRM servers or SEALDD storage server.

Store the created or updated spatial anchor locally within the XRM server and/or elsewhere in the system such as but not limited to a SEALDD storage server.

Based on information specified in the request (e.g., spatial anchor location, spatial anchor object ID), determine if the spatial anchor is to be anchored to a stationary/fixed location, orientation and distance (e.g., location, orientation and distance specified by the VAL server), or to an object that may move.

If a fixed location, orientation and distance is specified in the request, the XRM server may use this information in the request to configure the spatial anchor with a fixed location, orientation and distance.

If location, orientation and distance information is not provided in the request, the XRM server may leverage information elements in the request such as an ID of an object that the spatial anchor is to be anchored to. Using this information, the XRM server may perform one or more operations to obtain the current location, orientation and/or distance of the object as well as detect and track if/when the location, orientation and/or distance of the object changes. The XRM server may store this location, orientation and/or distance information within the spatial anchor and keep it updated if/when changes to location, orientation or distance of the object are detected. To perform these types of operations, the XRM server may query and/or subscribe to a location, orientation management server in the 3GPP system such as a SEAL location management server (e.g., using SEAL location client functionality supported by the XRM server). Alternatively, the XRM server may query the 3GPP core network (e.g., via the NEF location API) to a obtain the current location, orientation or distance of a UE and/or subscribe to receive notifications if the future location, orientation or distance updates of a UE changes.

Based on access control policies within the request and/or any local access control policies of the XRM server, the XRM server may configure the access control policies for the created spatial anchor.

Based on subscription information within the request and/or any local subscription policies of the XRM server, the XRM server may create and configure subscriptions to the spatial anchor.

Determine whether to enable the spatial anchor for access by other entities such as but not limited to SEALDD clients, VAL clients and/or other VAL servers. This determination may be based on spatial anchor context information specified in the request such as an availability time window or schedule of the spatial anchor itself and/or of the VAL server associated with the spatial anchor. Alternatively, the XRM server may enable the spatial anchor when the spatial anchor is created and disable it when it is deleted.

After enabling the spatial anchor, the XRM server may update the spatial anchor status to reflect whether the spatial anchor is active or inactive.

Step 3: Generate and return a spatial anchor create or update response to the VAL server that originated the request. Where the response may include but is not limited to one or more of the information elements defined in the table below.

| Response | |
|---|---|
| Element | Description |
| spatial anchor | See the tables above for a list of proposed spatial anchor |
| context | context Information elements that may be included. |
| information | |
| Status | Indication of whether the request was successfully |
| | processed or not. |

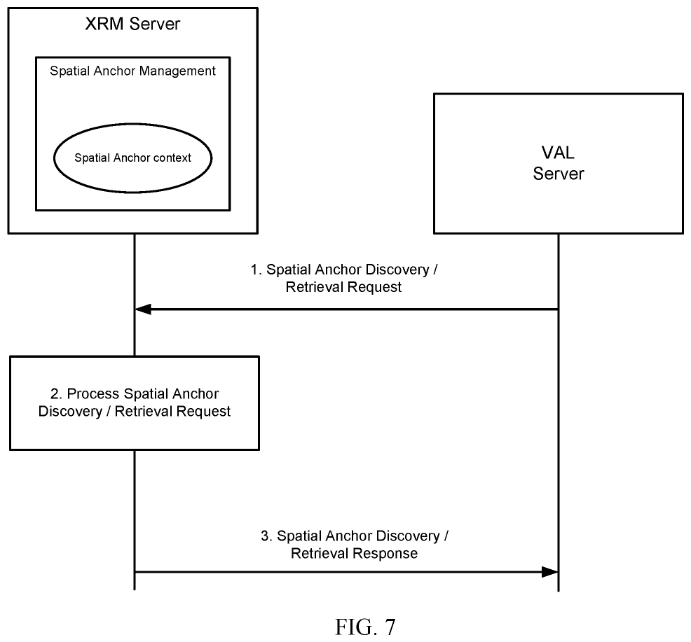

As shown in FIG. 7, a VAL server may initiate a request to an XRM server to retrieve or discover information regarding one or more spatial anchors.

Step 1: A VAL server may issue a request to an XRM server to retrieve context for one or more spatial anchors. Alternatively, the retrieval request may be used to discover one or more spatial anchors that match one or more specified criteria. The request may include but is not limited to one or more of the information elements defined in the table below.

| Request | |
|---|---|
| Element | Description |
| spatial | One or more criteria that may consist of variables, operators |
| anchor | and/or values. Where the variables may refer to spatial |
| criteria | anchor context information elements such as but not limited |
| | to the information elements defined in the tables above. The |
| | operators may include but are not limited to operators such |
| | as =, !=, <, >, <=, >=. The values may include numbers, |
| | strings, or complex types. Some examples of criteria may |
| | include but are not limited to a spatial anchor having: |
| | a spatial anchor associated with a specific VAL |
| | server ID or VAL service ID. |
| | a specific type or instance of a spatial anchor |
| | a spatial anchor status of enabled or disabled. |
| | a spatial anchor currently anchored to a specific |
| | object. |
| | a spatial anchor within a certain location and/or |
| | having a specific distance or orientation. |
| | a spatial anchor enabled to track/detect changes in |
| | location, orientation or distance of an object to |
| | which it is anchored to. |
| | a spatial anchor capable of performing ranging and |
| | detecting UEs in range of the spatial anchor. |
| | a spatial anchor having a particular type of linked or |
| | stored digital content. |
| | a spatial anchor associated with a VAL server |
| | having a specified VAL server availability schedule. |
| | a spatial anchor having a status that is active or |
| | inactive and/or having a specified availability |
| | schedule. |
| | a spatial anchor having one or more specified |
| | subscriptions. |
| | a spatial anchor having one or more specified access |
| | tokens, access control policies, and/or advertisement |
| | policies. |
| target | Address of the XRM server or another entity in the system |
| address | that is capable of receiving and processing spatial anchor |
| | retrieval or discovery requests. The address may include but |
| | is not limited to the following: |
| | IP address of the target XRM server |
| | Port of the target capable of receiving spatial anchor |
| | retrieval/discovery requests on |
| | Identifier of a resource or topic of the target (e.g., a |
| | URL) |
| VAL | Identifier of the VAL server initiating the request |
| server ID | |

Step 2: Upon receiving the request to retrieve or discover context for spatial anchors, the targeted XRM server may process the request by first checking whether the VAL server originating the request has permissions. This check may be performed by the XRM server checking that the VAL server ID specified in the request matches an ID specified in the access control privileges of the XRM server. The check may also be performed by checking whether a token specified in the request matches a token specified in the targets spatial anchor(s). The check may also include verifying the type of spatial anchor operation being performed (i.e., retrieval or discovery) is allowed and/or allowed at the current time and/or from the current location that the VAL server resides. If allowed, the XRM server processes the request. When processing the request, the XRM server may check whether the request includes filter criteria. If present, the XRM server may compare the specified filter criteria against context information within one or more spatial anchors stored locally by the XRM server. The XRM server may also send one or more requests to other entities in the network to retrieve or discover spatial anchors stored elsewhere in the network (e.g., stored within SEALDD server or another XRM server). When comparing the filter criteria, the XRM server may determine whether any spatial anchor context information matches the specified filter criteria.

Step 3: If one or more spatial anchors are found to match the filter criteria, then representations of the spatial anchor(s) are retuned in a response to the VAL server that originated the request. Alternatively, spatial anchor IDs (e.g., URls) may be returned. Otherwise, an error indication is retuned in the response indicating no spatial anchors matching the specified filter criteria were found. The response may include but is not limited to one or more of the information elements defined in the table below.

| Response | |
|---|---|
| Element | Description |
| spatial | See the tables above for a list of proposed spatial anchor |
| anchor | context Information elements that may be included for each |
| context | spatial anchor returned in the response. |
| information | |
| Status | Indication of whether the request was successfully |
| | processed or not. |

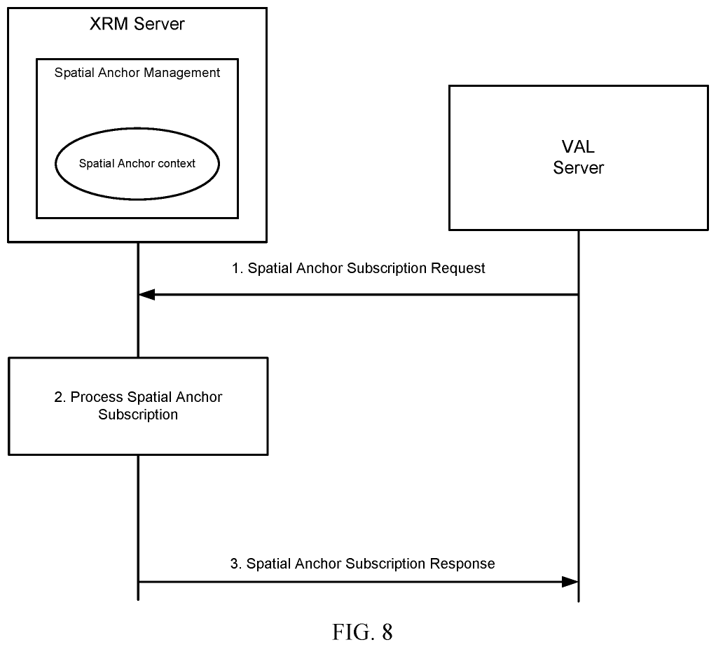

As shown in FIG. 8, a VAL server may initiate a request to an XRM server to subscribe to spatial anchor related events of interest to the VAL server which may be detected by the XRM server.

Step 1: A VAL server issues a spatial anchor subscription request to an XRM server, where the request may include but is not limited to one or more of the information elements defined in the table below.

| Request | |
|---|---|
| Element | Description |
| spatial | One or more criteria such as the spatial anchor criteria |
| anchor | specified in the tables above and/or one or more of the |
| subscription | following criteria: |
| criteria | A change in location, orientation or distance of the |
| | spatial anchor (or to the object anchored to the |
| | spatial anchor) which exceeds a specified threshold. |
| | Detection of UE(s) within the same location as the |
| | spatial anchor (or same location as the object which |
| | is anchored to the spatial anchor) |
| | Detection of UE(s) within a certain distance or |
| | having a certain orientation with respect to the |
| | spatial anchor (or object which is anchored to the |
| | spatial anchor). For example, a UE moving towards |
| | a spatial anchor. |
| | Detection of UE(s) within a specified range of the |
| | spatial anchor (or the object anchored to the spatial |
| | anchor) |
| | Detection of UE(s) having content interests which |
| | match the type of content linked or stored within a |
| | spatial anchor. |
| | Detecting a specified type of operation performed by |
| | the XRM server on the spatial anchor (e.g., spatial |
| | anchor discovery, retrieval, or subscription) |
| Targeted | Information regarding a targeted spatial anchor that may |
| spatial | include but is not limited to the following: |
| anchor | IP address of the targeted XRM server |
| | Port that the targeted XRM server receives spatial |
| | anchor context subscriptions requests on |
| | Identifier or address of a targeted spatial anchor |
| | (e.g., URL) |
| VAL | Identifier of the VAL server initiating the request |
| server ID | |

Step 2: Upon receiving the spatial anchor subscription request, the targeted XRM server may process the request by first checking whether the VAL server originating the request has permissions to subscribe to a spatial anchor on the XRM server. This check may be performed by the XRM server checking that the VAL server ID specified in the request matches an ID specified in the access control privileges of the XRM server. The check may also be performed by checking whether a token specified in the request matches a token specified in the targets spatial anchor(s). The check may also include verifying the type of XRM operation being performed is allowed as well as the operation is allowed to be performed at the current time and/or from the current location that the VAL server resides. If allowed, the XRM server processes the request. When processing the request, the XRM server may subscribe to location and/or ranging services and begin to monitor the spatial anchor subscription criteria specified in the request to detect if/when the criteria is met.

Step 3: Generate and return a spatial anchor subscription response to the VAL server that originated the request. Where the response may include but is not limited to one or more of the information elements defined in the table below.

| Response | |
|---|---|
| Element | Description |
| Subscription | Identifier of the spatial anchor subscription that has been |
| ID | created by the XRM server |
| Subscription | An expiration time for the subscription. |
| expiration | |
| spatial | See the tables above for a list of proposed Spatial Anchor |
| anchor | context Information elements that may be included in the |
| context | response. |
| information | |
| Status | Indication of whether the subscription request was |
| | successfully processed or not. |

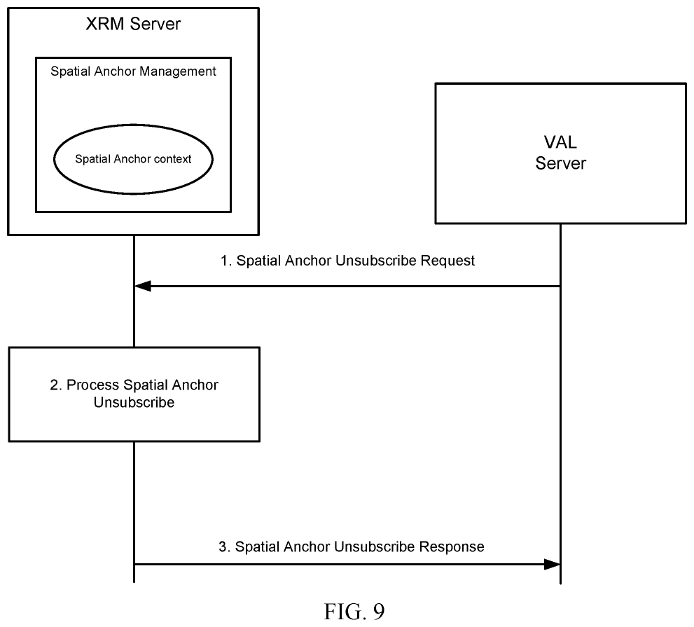

As shown in FIG. 9, VAL servers may initiate a request to an XRM server to unsubscribe from a spatial anchor such that the XRM server discontinues sending notifications associated with the subscription to the VAL server.

Step 1: A VAL server may unsubscribe from a spatial anchor by issuing a request to delete a specified spatial anchor subscription from an XRM server. The request may include but is not limited to one or more of the information elements defined in the table below.

| Request | |
|---|---|
| Element | Description |
| Subscription | The spatial anchor subscription identifier to delete. |
| ID | |
| spatial | One or more criteria such as the criteria specified in the |
| anchor | tables above. Note, rather than a filter criteria, this |
| filter | information element may instead be realized as a spatial |
| criteria | anchor ID. |
| XRM | Address of the XRM server targeted by this request which |
| server | may include but is not limited to the following: |
| | IP address of the targeted XRM server |
| | Port that the targeted XRM server receives spatial |
| | anchor unsubscribe requests on |
| | Identifier of a resource or topic that the targeted |
| | XRM server receives spatial anchor unsubscribe |
| | requests at |
| VAL | Identifier of the VAL server initiating the request |
| server ID | |

Step 2: Upon receiving the spatial anchor unsubscribe request, the targeted XRM server may process the request by first checking whether the VAL server originating the request has permissions to delete a spatial anchor subscription on the XRM server. This check may be performed by the XRM server checking that the VAL server ID specified in the request matches an ID specified in the access control privileges of the XRM server. The check may also be performed by checking whether a token specified in the request matches a token specified in the targets spatial anchor(s). The check may also include verifying the type of unsubscribe operation is allowed as well as the operation is allowed to be performed at the current time and/or from the current location that the VAL server resides. If allowed, the XRM server processes the request. When processing the request, the XRM server may perform one or more of the following operations based on spatial anchor context information contained within the request:

Delay processing of the unsubscribe request until the XRM server finishes processing/sending any outstanding notifications associated with the subscription. Alternatively, delete any stored (buffered) notifications associated with the spatial anchor subscription.

Trigger the tear-down of any underlying transports (e.g., PDU sessions, SEALDD flows, etc.) associated with notification targets associated with the spatial anchor subscription.

Stop monitoring the subscription criteria specified in the spatial anchor.

Delete any spatial anchor information stored locally at the XRM server or at other functions and services in the 3GPP system.

Delete any access control policies associated with the spatial anchor subscription.

Delete any additional subscriptions that the XRM server created with other functions and services in the 3GPP system in order to service this spatial anchor subscription (e.g., subscriptions to location management server, subscription to SEAL server, subscription to SEALDD server, etc.).

Step 3: Generate and return a spatial anchor unsubscribe response to the VAL server that originated the request. Where the response may include but is not limited to one or more of the information elements defined in the table below:

| Response | |
|---|---|
| Element | Description |
| spatial | See the tables above for a list of spatial anchor context |
| anchor | Information elements that may be included in the response. |
| context | |
| information | |
| Status | Indication of whether the spatial anchor unsubscribe request |
| | was successfully processed or not. |

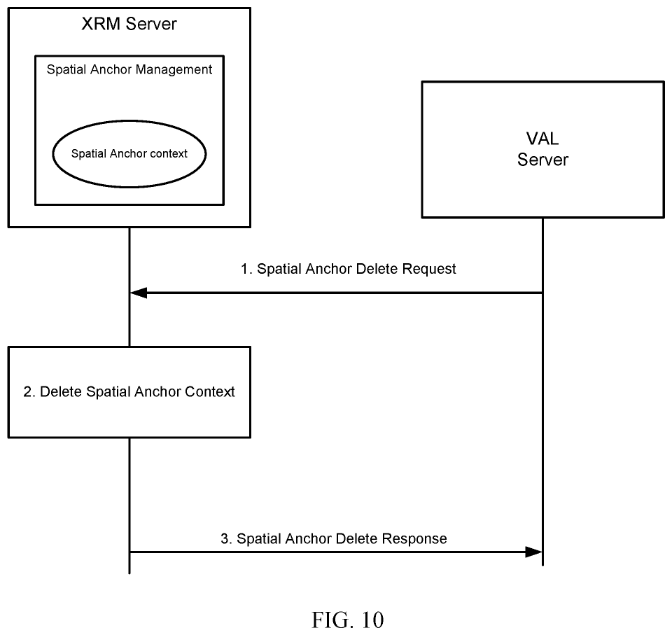

As shown in FIG. 10, a VAL server may initiate a request to an XRM server to delete a spatial anchor and any associated spatial anchor context information stored locally at the XRM server or elsewhere in the network (e.g., at a SEALDD server or another XR server).

Step 1: A VAL server may delete a spatial anchor by issuing a spatial anchor delete request to an XRM server. The request may include but is not limited to one or more of the information elements defined in the table below.

| Request | |
|---|---|
| Element | Description |
| spatial | One or more criteria such as the criteria specified in the |
| anchor | tables above. Note, rather than a filter criteria, this |
| ID or | information element may instead be realized as a spatial |
| filter | anchor ID. |
| criteria | |
| XRM | Address of the XRM server used to receive spatial anchor |
| server | delete requests which may include but is not limited to the |
| | following: |
| | IP address of the targeted XRM server |
| | Port that the targeted XRM server receives spatial |
| | anchor delete requests on |
| | Identifier of a resource or topic that the targeted |
| | XRM server receives spatial anchor delete requests |
| | at |
| VAL | Identifier of the VAL server initiating the request |
| server ID | |

Step 2: Upon receiving the spatial anchor delete request, the targeted XRM server may process the request by first checking whether the VAL server originating the request has permissions to delete a spatial anchor. This check may be performed by the XRM server checking that the VAL server ID specified in the request matches an ID specified in the access control privileges of the XRM server. The check may also be performed by checking whether a token specified in the request matches a token specified in the targets spatial anchor(s). The check may also include verifying the spatial anchor delete operation being performed is allowed to be performed at the current time and/or from the current location that the VAL server resides. If allowed, the XRM server processes the request. When processing the request, the XRM server may perform one or more of the following operations based on spatial anchor context information contained within the request or stored within the spatial anchor:

Delay processing of the delete request until the XRM server finishes any outstanding operations associated with the spatial anchor (e.g., notifications, retrieval, or discovery of the spatial anchor, etc.)

Trigger the tear-down of any underlying transports (PDU sessions. SEALDD flows) associated with the spatial anchor.

Delete any subscriptions associated with the spatial anchor and stop sending notifications to subscribers.

Notify subscribers (e.g., VAL servers) of the spatial anchor and subscriptions being deleted and that spatial anchor notifications associated with the spatial anchor will no longer be sent.

Reject any subsequent requests attempting to access the spatial anchor.

Delete any access control policies associated with the spatial anchor.

Delete any additional subscriptions or spatial anchor context that the XRM server created at other functions and services in the 3GPP system in order to service this spatial anchor (e.g., subscriptions to location management server, subscription to SEAL server, subscription to SEALDD server, etc.)

Step 3: Generate and return a spatial anchor delete response to the VAL server that originated the request. Where the response may include but is not limited to one or more of the information elements defined in the table below.

| Response | |
|---|---|
| Element | Description |
| spatial | See the tables above for a list of proposed spatial anchor |
| anchor | context Information elements that may be included for each |
| context | spatial anchor deleted. |
| information | |
| Status | Indication of whether the spatial anchor was successfully |
| | deleted or not. |

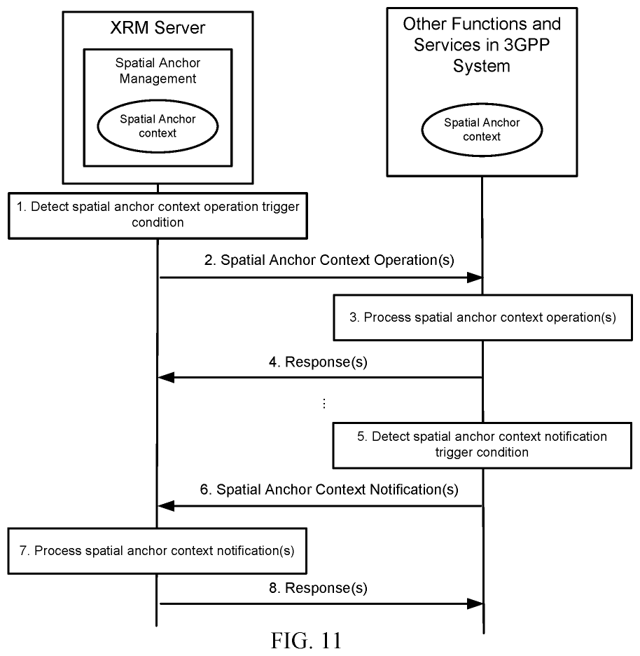

As shown in FIG. 11, for each spatial anchor that an XRM server manages on behalf of a VAL server, the XRM server may create and store spatial anchor context information locally on the XRM server. The spatial anchor context information may be comprised of one or more information elements such as but not limited to the information elements defined in the tables above. Alternatively, the XRM server may create and store spatial anchor context information remotely at other functions and services in the 3GPP system. For example, the XRM server may create and store spatial anchor context information at a SEALDD storage server, at a SEAL location management server, at a function in the core network, and/or at another XRM server (e.g., an XRM server deployed in another EDN). For cases where spatial anchor information is created and stored at a remote function or services elsewhere in the 3GPP system, an XRM server may also initiate discover, retrieve, update, subscribe, unsubscribe, and delete spatial anchor context operations to the remote functions and services.

Step 1: An XRM server detects a trigger condition for initiating a spatial anchor context operation to another function or service in the 3GPP system. For example, an XRM server may initiate spatial anchor context operations to other functions and services in the 3GPP system if/when it receives a corresponding spatial anchor operation from a VAL server. Alternatively, an XRM server may initiate these operations autonomously when detecting one or more types of events such as detecting a UE has come within range of a spatial anchor.

Step 2: The XRM server may send one or more spatial anchor context requests to one or more functions or services in the 3GPP system. The requests may include the information elements defined in the table below. The type of operations may include creating, updating, discovering, retrieving, or deleting spatial anchor context information stored on other functions or services in the 3GPP system. Another type of operation may include creating a subscription to spatial anchor context information stored on other functions or services in the 3GPP system. Within a subscription, the XRM server may define spatial anchor context criteria. For example, threshold values or filter conditions pertaining to one or more spatial anchor context information elements.

| Request | |
|---|---|
| Element | Description |
| Spatial | Type of operation spatial anchor context operation (e.g., |
| anchor | create, update, retrieve, discover, delete, subscribe, |
| context | unsubscribe) |
| operation | |
| Spatial | One or more filter or subscription criteria such as the |
| anchor | criteria specified in the tables above. Note, rather than a |
| context | criterion, this information element may instead be realized |
| criteria | as a spatial anchor ID. |
| Function | Address of the function or service in the 3GPP system |
| or service | targeted by the request which may include but is not limited |
| address | to the following: |
| | IP address of the targeted function or service |
| | Port that the targeted function or service server |
| | receives spatial anchor delete requests on |
| | Identifier of a resource or topic that the targeted |
| | function or service receives spatial anchor requests |
| | at |
| XRM | Identifier of the XRM server initiating the request |
| server ID | |

Step 3: Upon receiving the spatial anchor context request, the function or service may process the request by first checking whether the XRM server originating the request has permissions to perform the spatial anchor context operation. If allowed, the request is processed. When processing the request, the function or service may create, update, retrieve, discover, or delete spatial anchor context locally at the function or service. If the operation is a subscribe operation, the function or service may create a subscription and begin monitoring for any criteria specified in the subscription.

Step 4: Generate and return a spatial anchor context response to the XRM server that originated the request. Where the response may include but is not limited to one or more of the information elements defined in the table below.

| Response | |
|---|---|
| Element | Description |
| spatial | See the tables above for a list of proposed spatial anchor |
| anchor | context Information elements that may be included in the |
| context | response. |
| information | |
| Status | Indication of whether the spatial anchor context operation |
| | was successfully performed or not. |

Step 5: A function or service in the 3GPP system hosting spatial anchor context information and having one or more spatial anchor subscriptions, detects a trigger condition for initiating a spatial anchor context notification. For example, the function or service may initiate spatial anchor context notifications to an XRM server if/when it detects one or more types of events such as detecting a UE has come within range of a spatial anchor.

Step 6: The function or service sends one or more spatial anchor context notifications to one or more XRM servers. Within a notification, the function or service may include spatial anchor context information such as but not limited to the information elements defined in the tables above.

Step 7: Upon receiving the spatial anchor context notification, the XRM server may process the notification by performing operation such as but not limited to one or more of the following:

Extract and process spatial anchor context information included within the notification to detect a spatial anchor being created, modified, enabled, disabled, or deleted.

Detect updates to spatial anchor information such as but not limited to the information elements defined in the tables above.

Perform one or more actions in response to a spatial anchor notification such as but not limited to the following:

Compare spatial anchor context information received in the notification against subscription criteria stored locally on the XRM server.

Detect local subscription criteria has been met for a spatial anchor notification.

Issue a spatial anchor notification to a VAL server or UE.

Determine whether the location, orientation and/or distance of any UEs in proximity to the spatial anchor satisfy the updated spatial anchor context (e.g., spatial anchor service area) received in the notification.

Step 8: The XRM server may return a response back to the function or service indicating that it received and processed the spatial anchor context notification.

For each spatial anchor that an XRM server manages on behalf of a VAL server, the XRM server may perform anchoring operations to associate a spatial anchor with one or more objects in the 3GPP system, wherein an object may be a UE or a non-3GPP device. Once a spatial anchor is anchored to an object, the XRM server may keep the location, orientation and distance of the spatial anchor updated with the location, orientation and distance of the object. For example, if/when the XRM server detects changes to either the location, orientation or distance of the object, the XRM server may update the location, orientation and/or distance of the spatial anchor such that this information can be shared with other entities in the 3GPP system (e.g., VAL servers).

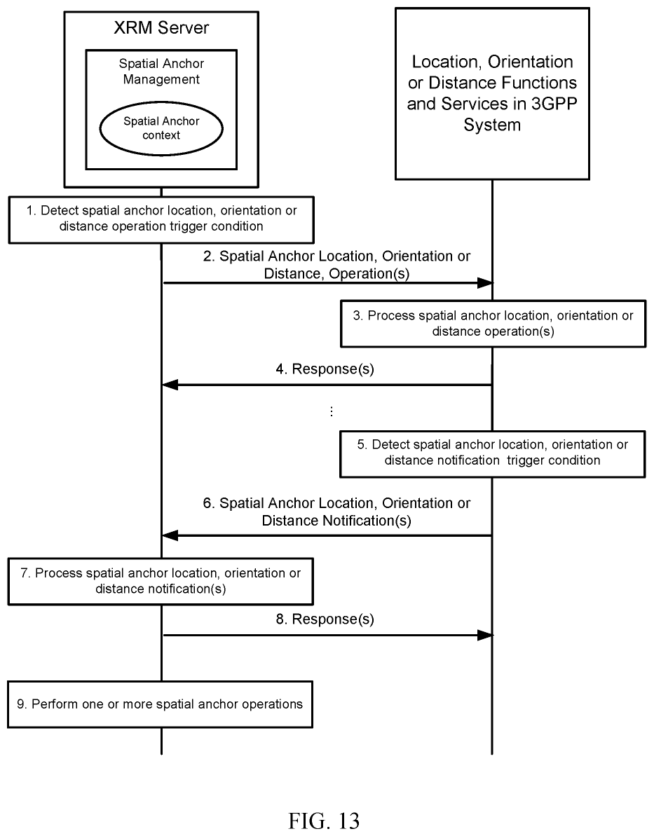

As shown in FIG. 13, an XRM server may interact with other functions or services in the 3GPP system to perform anchoring operations. For example, the XRM server may send an anchoring request to one or more functions or services in the 3GPP system (e.g., a core network function, a location management server, or one or more UEs) such that these functions and services are made aware of the anchoring association between a spatial anchor and an object. Leveraging this information, these functions and services may then provide spatial anchor aware functionality to the XRM server and/or other functions and services in the 3GPP system. For example, the location, orientation and/or distance of a spatial anchor may be updated automatically by a function or service if/when changes to the location, orientation and/or distance of the object anchored to the spatial anchor are detected.

Whether or not an XRM server performs anchoring operations for a given spatial anchor may be determined by one or more information elements configured within the spatial anchor. For example, an indicator such as the “Spatial anchor object ID” information element proposed in the tables above may be used by the XRM server to determine whether or not spatial anchor is to be anchored to an object or not.

Step 1: An XRM server may detect a trigger condition for initiating a spatial anchor anchoring operation to another function or service in the 3GPP system. For example, an XRM server may initiate spatial anchor anchoring operations to other functions and services in the 3GPP system if/when it receives a corresponding spatial anchor operation from a VAL server (e.g., creation or update of a spatial anchor). Alternatively, an XRM server may initiate these operations autonomously when detecting one or more types of events.

Step 2: The XRM server may send one or more spatial anchor anchoring operations to one or more functions or services in the 3GPP system. One type of operation may include sending a request to associate an object such as a UE or a non-3GPP device with a spatial anchor. The requests may include one or more of the following information elements:

Identifier(s) of a spatial anchor, an object anchored to a spatial anchor, and/or UE(s) in the proximity of a spatial anchor.

Location, orientation and/or distance requirements of the spatial anchor defining the location precision, format, and/or dimensionality required for location information returned for the UE.

Step 3: Upon receiving the anchoring request, the function or service may process the request by first checking whether the XRM server originating the request has permissions to perform the anchoring operation. If allowed, the request is processed.

Step 4: The function or service generates and return an anchoring response to the XRM server that originated the request. Where the response may include but is not limited to a status indicating whether the anchoring operation was performed successfully and/or the current location, orientation and/or distance of the object anchored to the spatial anchor.

Step 5: Upon receiving a spatial anchor ranging response or notification, the XRM server may perform additional spatial anchor operations such as update the spatial anchor context information, generate additional notifications to other entities in the 3GPP system (e.g., VAL servers, UEs, etc.), perform additional spatial anchor operations (e.g., ranging operations).

For each spatial anchor that an XRM server manages on behalf of a VAL server, the XRM server may perform location, orientation and/or distance management operations. The location management operations may include identifying the current or expected location of a spatial anchor, an object anchored to a spatial anchor, and/or UEs that come into the proximity of a spatial anchor. Location, orientation and/or distance management performed by the XRM server may include tracking the current location, orientation and/or distance of a spatial anchor, an object anchored to a spatial anchor, and/or UEs that come into the proximity of a spatial anchor if/when one or more of these entities change locations, orientations or change their distance from the spatial anchor.

As shown in FIG. 13, an XRM server may interact with other functions or services in the 3GPP system to perform location, orientation and/or distance management operations. For example, the XRM server may retrieve and/or subscribe to receive location, orientation and/or distance notifications from one or more functions or services in the 3GPP system (e.g., a core network function, a location management server, or one or more UEs). After receiving this location, orientation and/or distance information, the XRM server may determine whether this information is associated with a spatial anchor, an object anchored to a spatial anchor, and/or UEs in the proximity of a spatial anchor. The XRM server may store this location, orientation and/or distance information within a spatial anchor and or locally. Thereafter, the XRM server may also send a spatial anchor notification to other entities in the 3GPP system (e.g., VAL server, VAL clients) to make them aware of any spatial anchor location, orientation and/or distance updates to a spatial anchor, an object anchored to a spatial anchor, and/or UEs that come into the proximity of a spatial anchor.

Whether or not an XRM server performs location, orientation and/or distance management operations (for a given spatial anchor, object anchored to the spatial anchor, or UEs in proximity of spatial anchors) may be determined by one or more information elements configured within the spatial anchor. For example, an indicator such as the “spatial anchor tracking enabled” information element proposed in the tables above may be used by the XRM server to determine whether or not to track the location, orientation and/or distance for the purposes of spatial anchor management.

An XRM server may also use information elements configured within the spatial anchor to control how it performs location, orientation and/or distance management for a given spatial anchor. For example, the spatial anchor location requirements such as those defined in the tables above may be used by the XRM server to determine precision, type and/or format of location information collected and stored by the XRM server for a given spatial anchor. Based on these requirements, the XRM server may determine the type of location, orientation and/or distance functions and services it selects and interacts with in the 3GPP system. For example, the requirements may determine the frequency the XRM server interacts with these functions and services to meet the location, orientation and/or distance requirements of the spatial anchor. For example, if a spatial anchor requires location tracking with a precision of 1 m within a 3-dimensional axis, the XRM server may select a location function or service which is able to provide location tracking with these capabilities as well as the frequency which the XRM server receives updated information from the location function or service.

Step 1: An XRM server detects a trigger condition for initiating a spatial anchor location, orientation and/or distance operation to another function or service in the 3GPP system. For example, an XRM server may initiate spatial anchor location, orientation and/or distance operations to other functions and services in the 3GPP system if/when it receives a corresponding spatial anchor operation from a VAL server. Alternatively, an XRM server may initiate these operations autonomously when detecting one or more types of events such as a time duration has elapsed since the XRM server has received the last location, orientation or distance update for a spatial anchor, an object anchored to a spatial anchor, and/or UEs in the proximity of a spatial anchor.

Step 2: The XRM server sends one or more spatial anchor location, orientation or distance operations to one or more functions or services in the 3GPP system. One type of operation may include sending a request to discover and/or retrieve an updated location, orientation and/or distance of a spatial anchor, an object anchored to a spatial anchor, and/or UE(s) in the proximity of a spatial anchor. Another type of operation may include sending a request to subscribe to receive location, orientation and/or distance updates for a spatial anchor, an object anchored to a spatial anchor, and/or UE(s) in the proximity of a spatial anchor if/when specified criteria have been met. For example, a specified time period has elapsed since last location, orientation and/or distance update, a spatial anchor, an object anchored to a spatial anchor, and/or UE(s) in the proximity of a spatial anchor has moved more than a specified distance or changed its orientation by more than a specified threshold. The requests may also include one or more of the following information elements:

Identifier(s) of a spatial anchor, an object anchored to a spatial anchor, and/or UE(s) in the proximity of a spatial anchor.

The current or last known location(s), orientation(s) and/or distance(s) of a spatial anchor, an object anchored to a spatial anchor, and/or UE(s)

Location, orientation and/or distance requirements of the spatial anchor defining the location, orientation or distance precision, format, and/or dimensionality required for location, orientation, or distance information returned for the UE.

Step 3: Upon receiving the location, orientation and/or distance request, the function or service may process the request by first checking whether the XRM server originating the request has permissions to perform the spatial anchor location, orientation and/or distance operation. If allowed, the request is processed. When processing the request, the function or service may return location, orientation and/or distance information for a spatial anchor, an object anchored to a spatial anchor, and/or UE(s) in the proximity of a spatial anchor. If the operation is a subscribe operation, the function or service may create a subscription and begin monitoring for any location, orientation or distance criteria specified in the subscription.

Step 4: The function or service generates and returns a spatial anchor location, orientation and/or distance response to the XRM server that originated the request. Where the response may include but is not limited to a location, orientation and/or distance of the spatial anchor, an object anchored to the spatial anchor, and/or UE(s) in the proximity of the spatial anchor. The location, orientation and/or distance of an object anchored to the spatial anchor, and/or UE(s) in the proximity of the spatial anchor may be provided in an absolute format which is independent of the location, orientation and distance of the spatial anchor. Alternatively, it may be provided in relative format that is relative to the location, orientation and/or distance of the specified spatial anchor.

Step 5: A function or service in the 3GPP system hosting spatial anchor location, orientation and distance information and having one or more spatial anchor location, orientation and/or distance subscriptions, detects a trigger condition for initiating a spatial anchor location, orientation and/or distance notification. For example, the function or service may initiate notifications to an XRM server if/when it detects a change in the location, orientation or distance of a spatial anchor, an object anchored to a spatial anchor, and/or UE(s) in the proximity of a spatial anchor which meet or exceed the conditions specified in the criteria of the location, orientation and/or distance subscription from the XRM server.

Step 6: The function or service sends one or more spatial anchor location, orientation and/or distance notifications to the XRM server. Within a notification, the function or service may include location, orientation and/or distance information for one or more spatial anchors, objects anchored to a spatial anchor, and/or UEs in the proximity of a spatial anchor. The location, orientation and/or distance of an object anchored to a spatial anchor, and/or UE(s) in the proximity of a spatial anchor may be provided in an absolute format which is independent of the location, orientation and distance of the spatial anchor. Alternatively, it may be provided in relative format that is relative to the location, orientation and/or distance of a specified spatial anchor.

Step 7: Upon receiving the spatial anchor location, orientation and/or distance notification, the XRM server may process the notification.

Step 8: The XRM server may return a response back to the function or service indicating that it received and processed the spatial anchor location, orientation and/or distance notification.

Step 9: Upon receiving a spatial anchor location, orientation and/or distance response or notification, the XRM server may perform additional spatial anchor operations such as update the spatial anchor context information, generate additional notifications to other entities in the 3GPP system (e.g., VAL servers, UEs, etc.), perform additional spatial anchor operations (e.g., ranging operations).

For each spatial anchor that an XRM server manages on behalf of a VAL server, the XRM server may perform ranging operations to determine if/when UEs are within the service area of a spatial anchor. The ranging operations may include identifying the current location, orientation and/or distance of a spatial anchor (or object anchored to the spatial anchor) and detecting if/when the location, orientation and/or distance of one or more UEs meet the service area limits and requirements of the spatial anchor. For example, whether a UE is within a specified distance (e.g., within 500 ft) of a spatial anchor and has a certain orientation with respect to a spatial anchor (e.g., heading in a direction towards the spatial anchor or has a certain angle of arrival with respect to the spatial anchor).

As shown in FIG. 13, to identify the current location, orientation and distance of the spatial anchor, an object anchored to the spatial anchor, and/or one or more UEs, the XRM server may interface to one or more location, orientation and/or distance functions or services in the 3GPP system to assist it with collecting this information. For example, the XRM server may subscribe to location management functions and services in the 3GPP system to receive location, orientation and/or distance updates for UEs. Based on this information, the XRM server may compute a distance between the spatial anchor (or object anchored to the spatial anchor) and the one or more UE(s). The XRM server may also compute an alignment between the orientation of the UE(s) and the spatial anchor. The XRM server may then compare the computed distance to range limits defined for a spatial anchor and computed orientation to orientation requirements of the spatial anchor. The spatial anchor limits and requirements may be defined within the spatial anchor context information maintained by the XRM server (or another function or service in the 3GPP system) or configured via local policies of the XRM server.

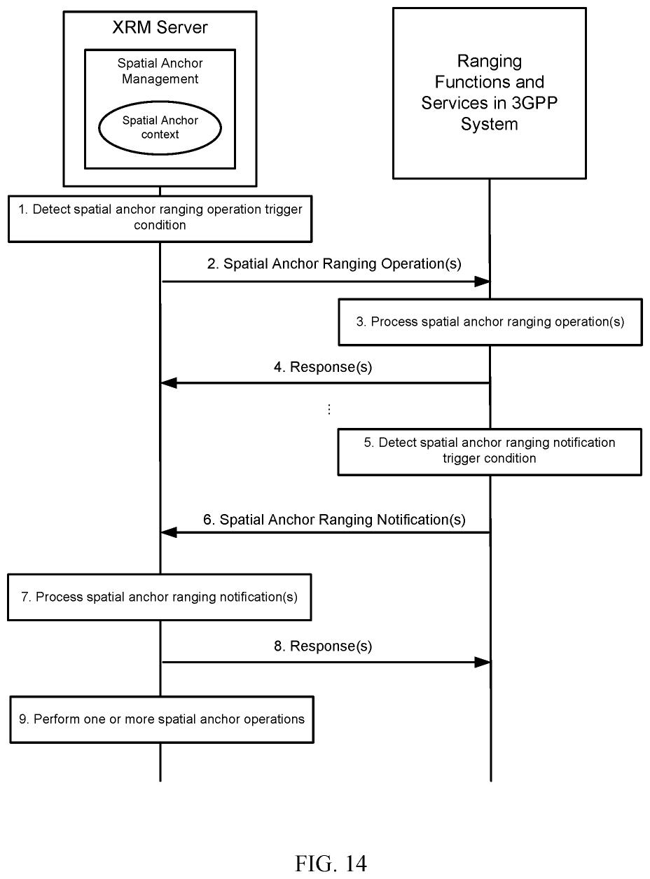

As shown in FIG. 14, rather than the XRM server locally computing whether the location, orientation and distance of UEs meet the service area range requirements of a spatial anchor, the XRM server may instead rely on ranging capabilities supported by other functions or services within the 3GPP system. For example, the XRM server may instead send a spatial anchor ranging request to one or more other functions or services in the 3GPP system. These others functions or services may then compute ranging distances and orientations between the spatial anchor and UEs and return the computed results back to the XRM server. The XRM server may then compare the computed ranging results against service area ranging limits and requirements defined for spatial anchors to detect if/when UEs meet the specified service range requirements of the spatial anchor. Yet another alternative is for the XRM server to provide service area ranging limits and requirements for a spatial anchor to the other functions or services in the 3GPP system. The XRM server may then rely on the other function or service to detect if/when UEs are detected within the specified service area range limits and requirements of a spatial anchor. If/when this occurs, the XRM server may receive a notification from the other functions or services indicating one or more UEs have been detected within the service area range limits and requirements of the spatial anchor.

Step 1: An XRM server detects a trigger condition for initiating a spatial anchor ranging operation to another function or service in the 3GPP system. For example, an XRM server may initiate spatial anchor ranging operations to other functions and services in the 3GPP system if/when it receives a spatial anchor operation from a VAL server (e.g., to create a spatial anchor). Alternatively, an XRM server may initiate these operations autonomously when detecting one or more types of events such as the XRM server receiving location, orientation and/or distance information for UE(s).

Step 2: The XRM server sends one or more spatial anchor ranging operations to one or more functions or services in the 3GPP system. The type of operations may include sending a request to a ranging function in the core network or elsewhere in the 3GPP system to retrieve the range of a UE with respect to a spatial anchor. Alternatively, the request may include sending a subscription to receive spatial anchor ranging notifications for a UE if/when specified spatial anchor ranging criteria have been met. For example, if/when the location, orientation and distance of UE meet the spatial anchor service area range limits and requirements, then a notification may be received. The requests may also include one or more of the following information elements:

Location, orientation and/or distance requirements of the spatial anchor defining the location precision, format, and/or dimensionality required for location information returned for the UE.

The current location, orientation and/or distance of a UE.

The current location, orientation and/or distance of a spatial anchor such that the location, orientation and/or distance information of the UE may be provided relative to the spatial anchor's location, orientation and/or distance (e.g., UE is headed towards spatial anchor and is 300 ft away).

Spatial anchor service area range limits and requirements.

Step 3: Upon receiving the spatial anchor ranging request, the function or service may process the request by first checking whether the XRM server originating the request has permissions to perform the spatial anchor ranging operation. If allowed, the request is processed. When processing the request, the function or service may return ranging information for a UE with respect to the spatial anchor. If the operation is a subscribe operation, the function or service may create a subscription and begin monitoring for any ranging criteria specified in the subscription.

Step 4: The ranging function or service in the 3GPP system generates and return a spatial anchor ranging response to the XRM server that originated the request. Where the response may include but is not limited to a distance and a orientation of the UE with respect to the spatial anchor. The response may also include an indication whether the location, orientation and/or distance of the UE meets the service area range limits and requirements of the spatial anchor.

Step 5: The ranging function or service in the 3GPP system, having one or more spatial anchor ranging subscriptions, detects a trigger condition for initiating a spatial anchor ranging notification. For example, the function or service may initiate notifications to an XRM server if/when it detects a change in a UE's location, orientation or distance which meets the ranging limits/requirements specified in the criteria of the spatial anchor ranging subscription from the XRM server.

Step 6: The ranging function or service sends one or more spatial anchor ranging notifications to one or more XRM servers. Within a notification, the function or service may include ranging information for one or more UEs relative to a spatial anchor. The notification may also include an indication that the location, orientation and/or distance of the UE meets (or no longer meets) the service area range limits and requirements of the spatial anchor.

Step 7: Upon receiving the spatial anchor ranging notification, the XRM server may process the notification by performing spatial anchor ranging operations to determine whether the ranging information provided in the notification meets the service area range limits and requirements of the spatial anchor (if this information is not provided within the notification received from the ranging function or service).

Step 8: The XRM server may return a response back to the function or service indicating that it received and processed the spatial anchor ranging notification.

Step 9: After receiving a ranging response or notification, the XRM server may use this information to detect one or more UEs that have met the service area range limits and requirements of a spatial anchor. Thereafter, the XRM server may perform one or more of the following actions:

Determine whether the UE(s) are allowed to have awareness and knowledge of the spatial anchor and the information stored within a spatial anchor and/or linked to a spatial anchor. The XRM server may use information elements configured within a spatial anchor, local policies of the XRM server, and/or additional information that the XRM server receives from other functions or services in the 3GPP system to make this determination. For example, the XRM server may receive and/or determine an identifier of a UE (e.g., UE ID) and/or an identifier of an application or service on the UE (e.g., XRM client ID, VAL client ID). This information may be provided to the XRM server from the UE or another function or service in the 3GPP system. Using this information, the XRM server may compare it against spatial anchor access control policies to determine if the UE is permitted to have awareness and knowledge of the spatial anchor. The XRM server may also check spatial anchor advertisement policies configured within a spatial anchor to determine if sharing (i.e., advertising) spatial anchor information with the UE is permitted. The XRM server may also issue a request to a VAL server associated with a spatial anchor to request permission from the VAL server to share spatial anchor information with a UE. The XRM server may also query another function or service in the 3GPP system to determine whether the UE wishes to receive information regarding spatial anchors.

Determine whether the UE(s) or their owner(s) have provided consent to have the UE's location tracked and detecting if/when the UE has come within the range limits of one or more consented types of spatial anchors. The XRM server may use information stored locally at the XRM service to make this determination. Alternatively, the XRM server may query information (e.g., device and/or user profile information) from one or more functions or services in the 3GPP system. For example, in one embodiment, the XRM server may query a 3GPP defined CAPIF authorization function.

Determine whether the spatial anchor is of interest to the UE(s) that have come within the range limits of one or more types of spatial anchors. The XRM server may use information stored locally at the XRM service to make this determination. Alternatively, the XRM server may query information from one or more functions or services in the 3GPP system. For example, in one embodiment, the XRM server may query information such as the types of applications or services supported by a UE (e.g., VAL service IDs), the types of spatial anchors (e.g., spatial anchor IDs) of interest to the UE, the types of spatial anchor content (e.g., VAL content ID) of interest to the UE, a scheduled time window of when the UE is interested in spatial anchors, an indication of whether the object is currently interested in spatial anchors, and/or a scheduled time window of when the object is interested in spatial anchors.

Create spatial anchor notifications comprising spatial anchor information such as but not limited to the types of information defined in the table below.

Send the spatial anchor notifications to one or more UEs detected within range of the spatial anchor or to one or more VAL servers having an association with the spatial anchor.

Whether or not an XRM server performs ranging operations for a given spatial anchor may be determined by one or more information elements configured within the spatial anchor. For example, an indicator such as the “spatial anchor ranging enabled” information element proposed in Table 1 may be used by the XRM server to determine whether or not to track and detect location of UEs and if the UEs come within the defined range limits of the spatial anchor (or object anchored to spatial anchor).

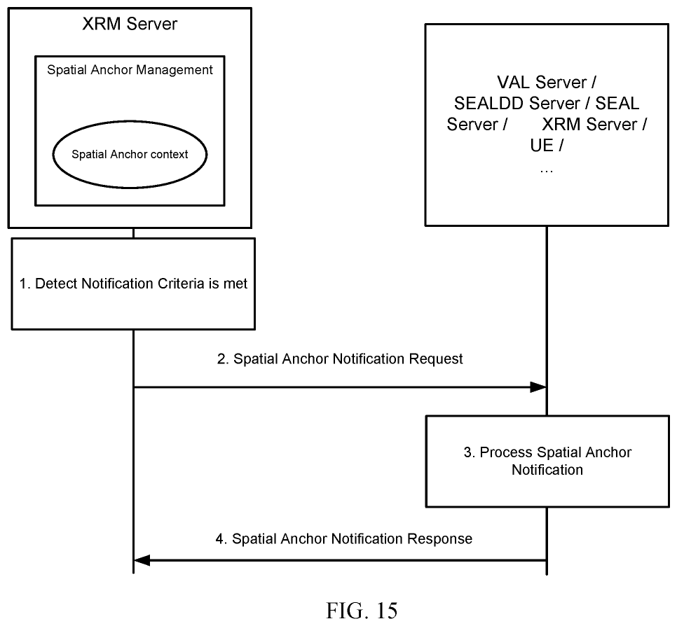

As shown in FIG. 15, an XRM server may send spatial anchor notifications to one or more entities in a 3GPP system such as but not limited to VAL servers, UEs, SEALDD servers, SEAL servers, and other XRM servers.

Step 1: An XRM server detects that spatial anchor notification criteria have been met. The detection of notification criteria by the XRM server may involve detecting one or more events such as but not limited to the following:

A change in the location, orientation and/or distance of a spatial anchor, an object anchored to a spatial anchor, or one or more UE(s) in the proximity of a spatial anchor.

Detecting that one or more UEs have met (or no longer meet) the spatial anchor service area range limits or requirements.

A change in the spatial anchor service area range limits or requirements.

A change in one or more VAL servers associated with a spatial anchor and/or update to the VAL server callback address(s).

A new/different object being anchored to the spatial anchor.

Spatial anchor location tracking being enabled or disabled for the spatial anchor.

Spatial anchor ranging being enabled or disabled for the spatial anchor.

New/updated content or services being linked to a spatial anchor or being stored within the context information of a spatial anchor.

A change in the availability status or schedule of a spatial anchor.

A change in the availability status and/or schedule of one or more VAL servers providing content associated with a spatial anchor.

A change to spatial anchor access control or advertisement policies.

The spatial anchor related events may be detected by the XRM server based on operations performed on a spatial anchor and/or upon spatial anchor event criteria defined within a spatial anchor subscription. Spatial anchor event criteria may by defined within individual information elements within spatial anchors and/or within individual subscriptions to spatial anchors. Alternatively, these criteria may be defined within local policies configured on the XRM server. An XRM server may monitor and detect if/when the configured criteria have been met and then generate one or more spatial anchor notifications.

Step 2: If/when an XRM server detects that the notification criteria have been met, it may generate one or more spatial anchor notifications that may include but are not limited to one or more of the information elements defined in the table below. To determine which information to include in a spatial anchor notification, the XRM server may rely on one or more of the following: a notification content parameter specified within the spatial anchor or a spatial anchor subscription which defines which information elements of the spatial anchor to include in the notification, an access control and/or advertisement policy defining access control rules regarding which entities are allowed to access certain information elements of the spatial anchor, and/or local policies.

| Request | |
|---|---|
| Element | Description |
| Notification | Identifier of this spatial anchor notification |
| ID | |
| Subscription | Identifier of the spatial anchor subscription associated with |
| ID | this notification |
| Spatial | See the tables above for a list of spatial anchor context |
| anchor | Information elements that may be included. |
| context | |
| information | |
| Spatial | Indicators of one or more events that triggered and caused |
| anchor | the spatial anchor notification |
| event(s) | |
| Target | Information regarding the target of this spatial anchor |
| | notification: |
| | IP address of the target |
| | Port that the target receives spatial anchor |
| | notifications on |
| | Identifier of a resource or topic (e.g., URI, topic |
| | name, etc.) that the target receives spatial anchor |
| | notifications |
| XRM | Identifier of the XRM server initiating the spatial anchor |
| server ID | notification request |

Step 3: Upon receiving the spatial anchor notification request, the target may perform one or more follow-on operations based on spatial anchor centric information. The follow-on operations may include the target sending one or more of the following requests to the XRM server to process:

A request to obtain privileges to access information elements of the spatial anchor, an object anchored to the spatial anchor, content linked to the spatial anchor, or a service linked to the spatial anchor.

A request to perform an operation targeting the spatial anchor such as a discover, retrieve, update, or subscribe operation to the spatial anchor.

A request to retrieve content linked to the spatial anchor (e.g., content hosted by a VAL server for which the spatial anchor contains a link to).

A request to access a service linked with the spatial anchor (e.g., a service accessible via a VAL server for which the spatial anchor contains a link to).

A request to perform an action on the object anchored to the spatial anchor (e.g., activate a switch upon a device anchored to the spatial anchor).

Upon receiving one or more of the above requests, the XRM server may process the requests. When processing the received requests, the XRM server may interface to one or more VAL servers and/or other functions or services in the 3GPP system. For example, the XRM server may forward a spatial anchor content request to a VAL server to process. When processing the received requests, the XRM server may use spatial anchor context information stored in a spatial anchor. For example, the XRM server may use a VAL server ID, VAL server callback address and/or VAL server content or service link stored in a spatial anchor to determine where to forward a spatial anchor content or service request to. Likewise, an XRM server may use a of a VAL server availability schedule information to determine when to schedule and forward a spatial anchor content or service request to a VAL server. Alternatively, an XRM server may service a request to access spatial anchor content by retrieving content that is stored within a spatial anchor and returning this content to the requestor.

Step 4: The target may generate and return a spatial anchor notification response to the XRM server that originated the notification request.

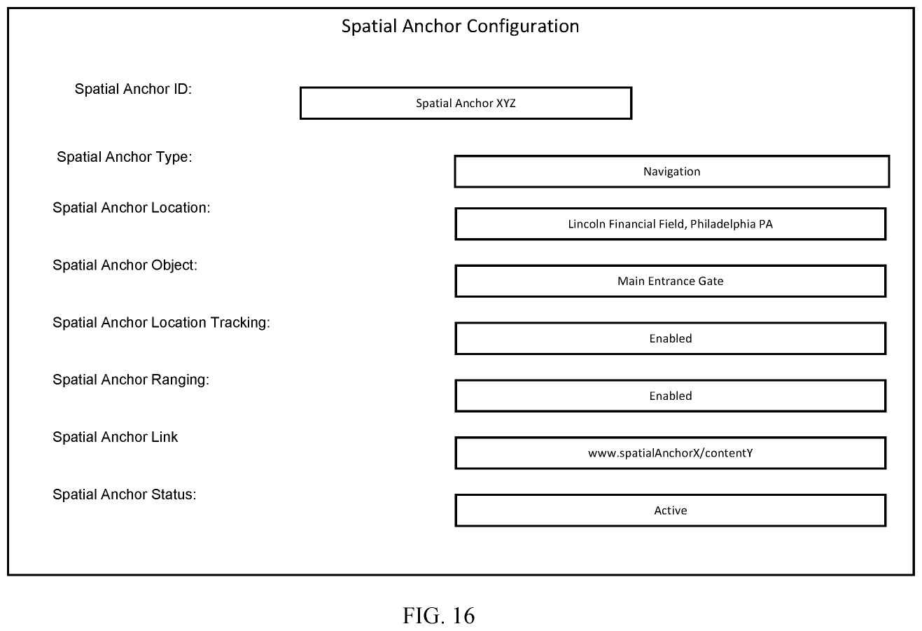

FIG. 16 shows an example of a graphical user interface for a spatial anchor server that could leverage the network centric spatial anchor capabilities proposed in this invention. Via this GUI a service provider could create spatial anchors within the 3GPP system that are anchored to a particular location (e.g., a stadium).

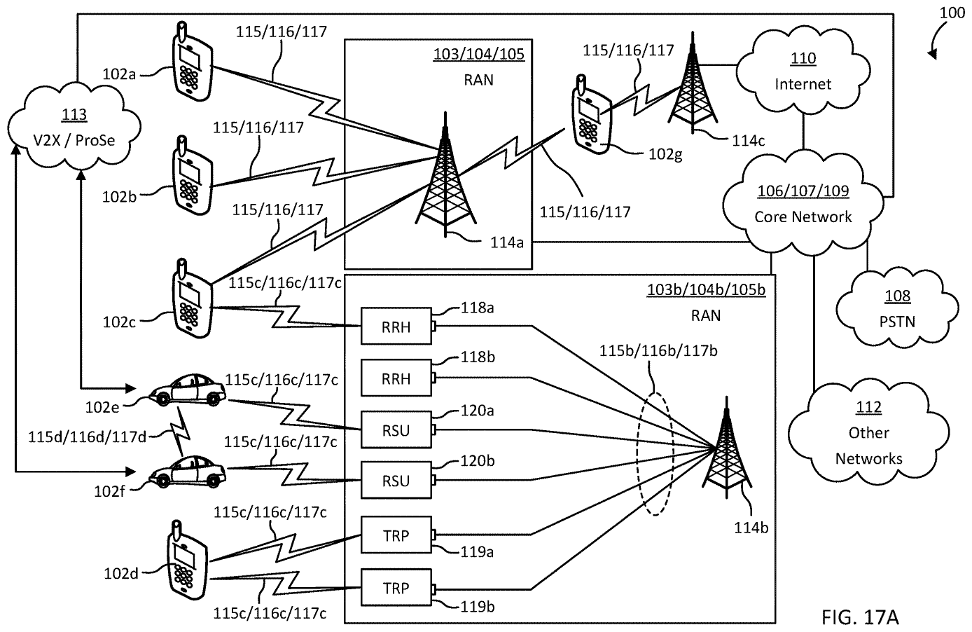

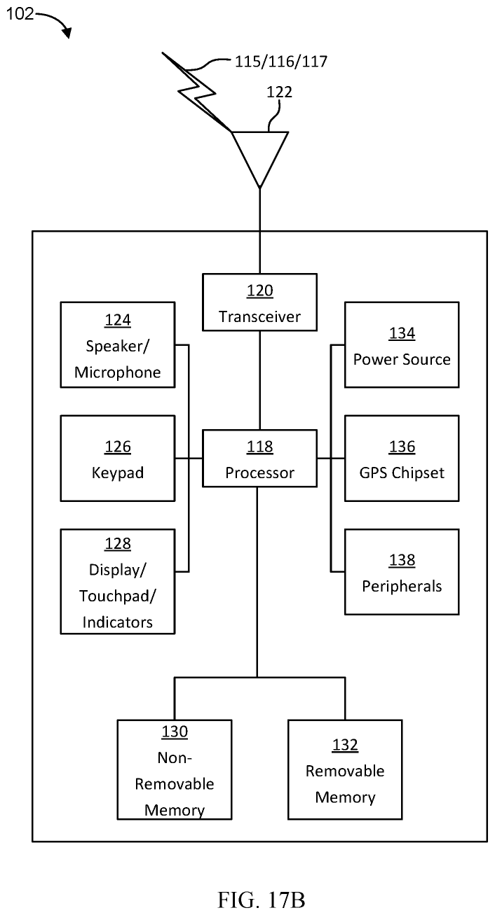

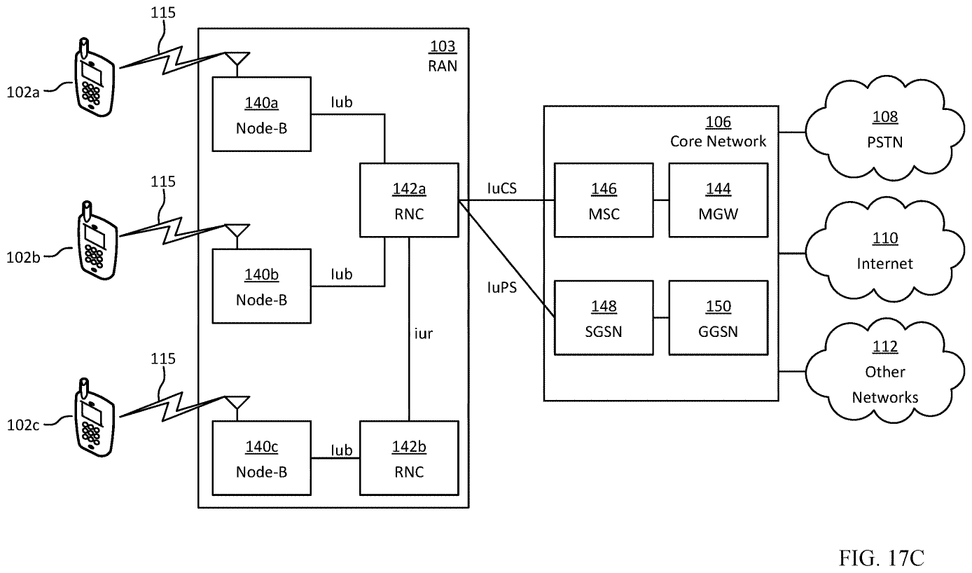

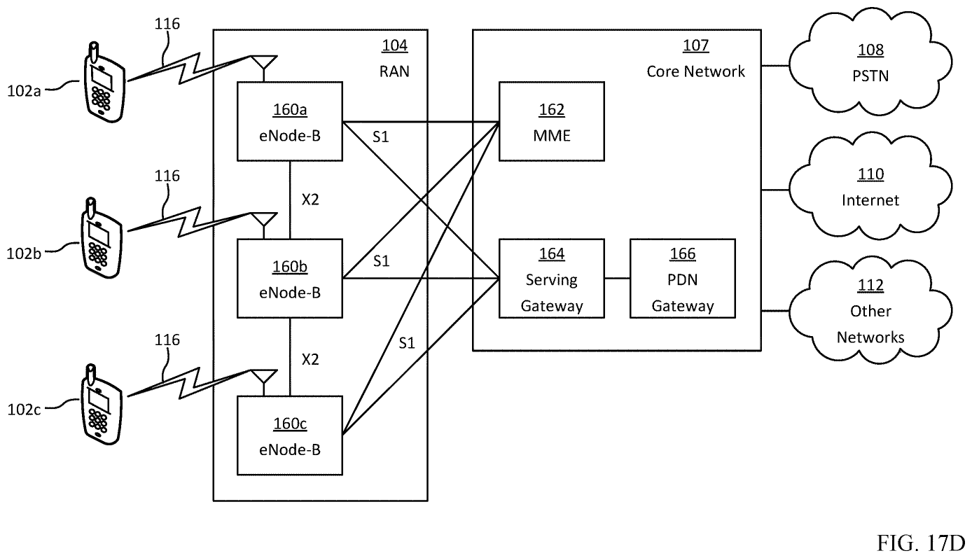

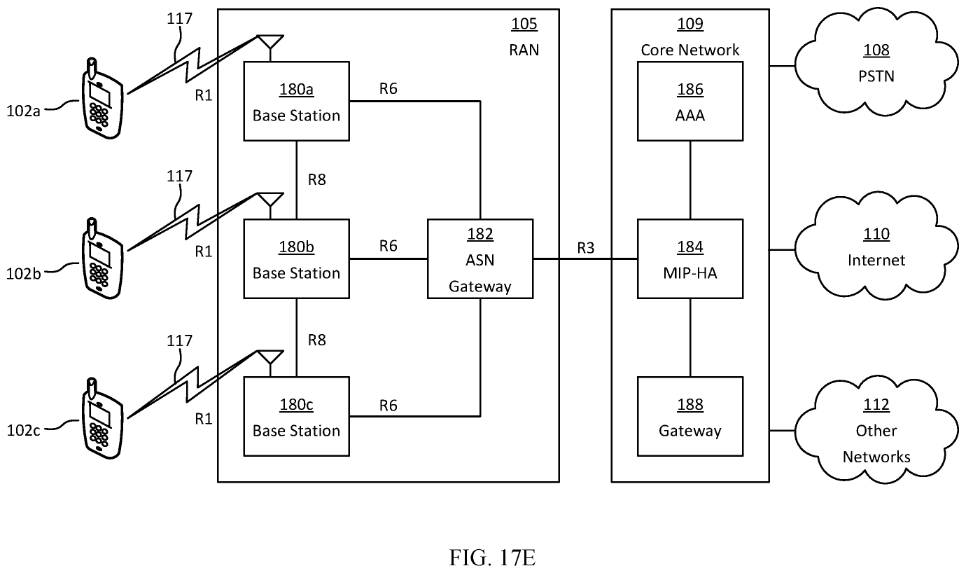

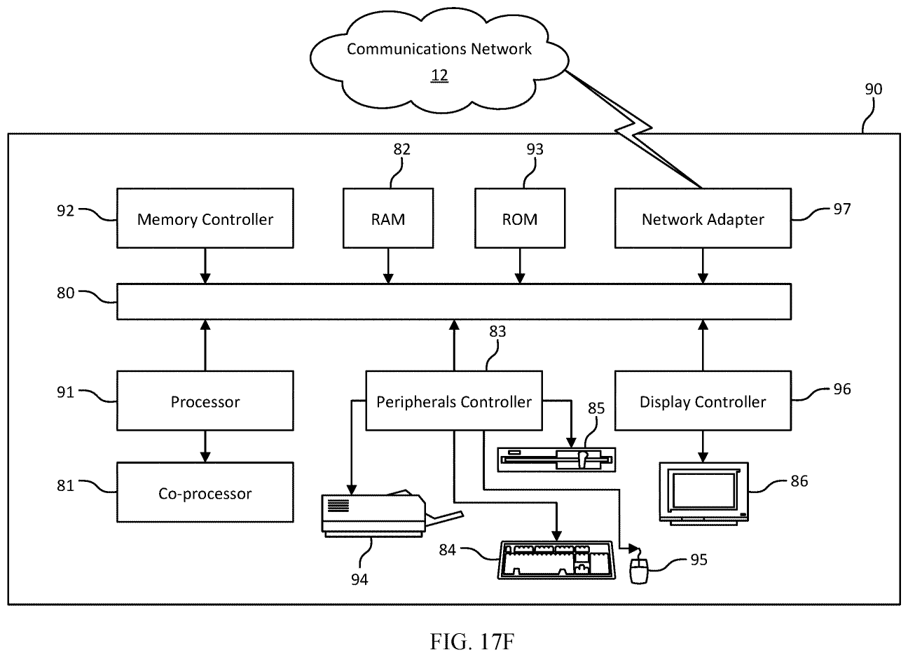

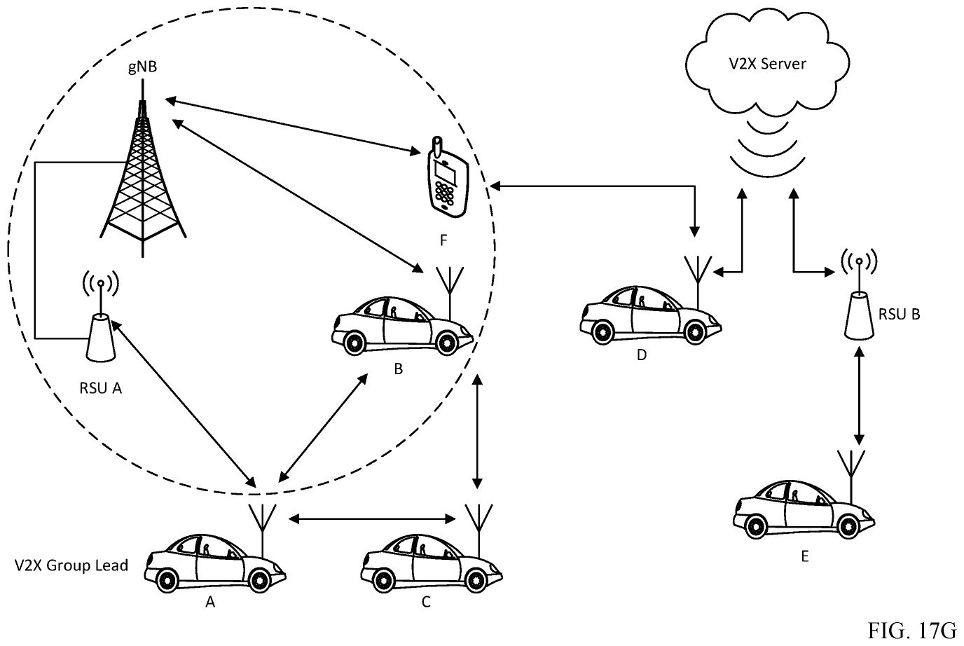

FIG. 17A illustrates one embodiment of an example communications system 100 in which the methods and apparatuses described and claimed herein may be embodied. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed embodiments contemplate any number of WTRUs, base stations, networks, and/or network elements. Each of the WTRUs 102a, 102b. 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 17A-17E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Tenn Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In an embodiment, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 17A may be a wireless router, Home Node B, Home eNode B. or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 17A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 17A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102c may include multiple transceivers for communicating with different wireless networks over different wireless links. For example, the WTRU 102e shown in FIG. 17A may be configured to communicate with the base station 114a, which may employ a cellular-based radio technology, and with the base station 114c, which may employ an IEEE 802 radio technology.

FIG. 17B is a block diagram of an example apparatus or device configured for wireless communications in accordance with the embodiments illustrated herein, such as for example, a WTRU 102. As shown in FIG. 17B, the example WTRU 102 may include a processor 118, a transceiver 120, a transmit/receive element 122, a speaker/microphone 124, a keypad 113, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 17B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 17B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 17B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 17C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 17C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 17C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a. 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 17C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 17D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 17D, the eNode-Bs 160a, 160b, 160c may communicate with one another over an X2 interface.

The core network 107 shown in FIG. 17D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a. 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 17E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 17E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a. 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 17E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a. 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 17E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 17A, 17C, 17D, and 17E are identified by the names given to those entities in certain existing 3GPP specifications, but it is understood that in the future those entities and functionalities may be identified by other names and certain entities, or functions may be combined in future specifications published by 3GPP, including future 3GPP NR specifications. Thus, the particular network entities and functionalities described and illustrated in FIGS. 17A, 17B, 17C, 17D, and 17E are provided by way of example only, and it is understood that the subject matter disclosed and claimed herein may be embodied or implemented in any similar communication system, whether presently defined or defined in the future.

FIG. 17F is a block diagram of an exemplary computing system 90 in which one or more apparatuses of the communications networks illustrated in FIGS. 17A, 17C, 17D and 17E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 17A, 17B, 17C, 17D, and 17E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 17G illustrates one embodiment of an example communications system 111 in which the methods and apparatuses described and claimed herein may be embodied. As shown, the example communications system 111 may include wireless transmit/receive units (WTRUs) A, B, C, D, E, F, a base station, a V2X server, and a RSUs A and B, though it will be appreciated that the disclosed embodiments contemplate any number of WTRUs, base stations, networks, and/or network elements. One or several or all WTRUs A, B, C, D, E can be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1. A method comprising:
receiving, from a VAL server and by a XRM server, a request to create a spatial anchor, wherein the request comprises spatial anchor contextual information and identification information of the VAL server;
determining, by the XRM server, the VAL server has permission to create the spatial anchor;
generating, by the XRM server, the spatial anchor according to the contextual information; and
storing, by the XRM server, the spatial anchor.

2. The method of claim 1, wherein the determining is based on the identification information received in the request.

3. The method of claim 1, wherein the request further comprises identification information of the XRM server.

4. The method of claim 3, wherein the identification information of the XRM server comprises an IP address for the XRM server, a reception port identifier for the XRM server, a resource identifier of a resource hosted by the XRM server corresponding to the spatial anchor, or a combination thereof.

5. The method of claim 1, further comprising:
assigning a spatial anchor identifier to the spatial anchor.

6. The method of claim 1, further comprising:
configuring the spatial anchor with a fixed location parameter, a fixed orientation parameter, a fixed distance parameter, or a combination thereof.

7. The method of claim 1, further comprising:
determining location information, orientation information, distance information, or a combination thereof, of an object the spatial anchor is anchored to; and
storing the location information, orientation information, distance information, or the combination thereof, with the spatial anchor.

8. The method of claim 1, further comprising:
configuring access control policies for the spatial anchor; and
storing the access control policies with the spatial anchor.

9. The method of claim 1, wherein the spatial anchor contextual information comprises fixed location information of an object the spatial anchor is to be anchored to, dynamic location information of an object the spatial anchor is to be anchored to, object characteristic information of an object the spatial anchor is to be anchored to, spatial anchor advertisement policy information, spatial anchor access control policy information, spatial anchor access token information, spatial anchor discovery information, spatial anchor subscription information, spatial anchor scheduling information, spatial anchor active status information, spatial anchor content information, or a combination thereof.

10. The method of claim 1, further comprising:
configuring subscription policies for the spatial anchor; and
storing the subscription policies with the spatial anchor.

11. The method of claim 1, further comprising:
sending, to the VAL server, a response indicative of the generating of the spatial anchor, wherein the response comprises information stored with the spatial anchor, status of successful processing of the request, or both.

12. The method of claim 1, further comprising:
receiving, from the VAL server, a request to update the spatial anchor, wherein the request to update the spatial anchor comprises an identifier of the spatial anchor, an application service identifier, and instructions for updating the spatial anchor;
determining, based on the request to update, the spatial anchor is stored; and
modifying the spatial anchor according to the instructions.

13. The method of claim 12, further comprising:
sending, to the VAL server, a response indicative of the modifying of the spatial anchor.

14. An apparatus comprising:
one or more processors; and
memory storing instructions which, when executed by the one or more processors, cause the apparatus to:
receive, from a VAL server, a request to create a spatial anchor, wherein the request comprises spatial anchor contextual information and identification information of the VAL server;
determine the VAL server has permission to create the spatial anchor;
generate the spatial anchor according to the contextual information; and
store the spatial anchor.

15. The apparatus of claim 14, wherein the determining is based on the identification information received in the request.

16. The apparatus of claim 14, wherein the request further comprises identification information of the apparatus.

17. The apparatus of claim 16, wherein the identification information of the apparatus comprises an IP address for the apparatus, a reception port identifier for the apparatus, a resource identifier of a resource hosted by the apparatus corresponding to the spatial anchor, or a combination thereof.

18. The apparatus of claim 14, wherein the instructions, when executed, further cause the apparatus to:
assign a spatial anchor identifier to the spatial anchor.

19. The apparatus of claim 14, wherein the instructions, when executed, further cause the apparatus to:
configure the spatial anchor with a fixed location parameter, a fixed orientation parameter, a fixed distance parameter, or a combination thereof.

20. The apparatus of claim 14, wherein the instructions, when executed, further cause the apparatus to:
determine location information, orientation information, distance information, or a combination thereof, of an object the spatial anchor is anchored to; and
store the location information, orientation information, distance information, or the combination thereof, with the spatial anchor.

21. The apparatus of claim 14, wherein the instructions, when executed, further cause the apparatus to:
configure access control policies for the spatial anchor; and
store the access control policies with the spatial anchor.

22. The apparatus of claim 14, wherein the spatial anchor contextual information comprises fixed location information of an object the spatial anchor is to be anchored to, dynamic location information of an object the spatial anchor is to be anchored to, object characteristic information of an object the spatial anchor is to be anchored to, spatial anchor advertisement policy information, spatial anchor access control policy information, spatial anchor access token information, spatial anchor discovery information, spatial anchor subscription information, spatial anchor scheduling information, spatial anchor active status information, spatial anchor content information, or a combination thereof.

23. The apparatus of claim 14, wherein the instructions, when executed, further cause the apparatus to:
configure subscription policies for the spatial anchor; and
store the subscription policies with the spatial anchor.

24. The apparatus of claim 14, wherein the instructions, when executed, further cause the apparatus to:
send, to the VAL server, a response indicative of the generating of the spatial anchor, wherein the response comprises information stored with the spatial anchor, status of successful processing of the request, or both.

25. The apparatus of claim 14, wherein the instructions, when executed, further cause the apparatus to:
receive, from the VAL server, a request to update the spatial anchor, wherein the request to update the spatial anchor comprises an identifier of the spatial anchor, an application service identifier, and instructions for updating the spatial anchor;
determine, based on the request to update, the spatial anchor is stored; and
modify the spatial anchor according to the instructions.

26. The apparatus of claim 25, wherein the instructions, when executed, further cause the apparatus to:
send, to the VAL server, a response indicative of the modifying of the spatial anchor.
